(19) United States
(12) Patent Application Publication
(10) Pub. No.: US 2026/0056821 A1
(43) Pub. Date: Feb. 26, 2026

(54) ENHANCING RELIABILITY OF ARTIFICIAL INTELLIGENCE OPERATIONAL PIPELINES

(71) Applicant: The Toronto-Dominion Bank, Toronto (CA)

(72) Inventors: Robert Matthew Meyer, Toronto (CA); Chenzi Qie, Toronto (CA); Wen-Yang Ku, Toronto (CA); Maksims Volkovs, Toronto (CA)

(73) Assignee: The Toronto-Dominion Bank, Toronto (CA)

(21) Appl. No.: 18/813,238

(22) Filed: Aug. 23, 2024

(51) Int. Cl. G06F 11/07; G06N 20/00

(52) U.S. Cl. CPC G06F 11/0772; G06N 20/00

(57) ABSTRACT

An example operation may include one or more of integrating a trained AI model into an AI pipeline via a software application, receiving input data via the software application and starting execution of the AI pipeline on the input data, determining, during runtime of the AI pipeline, that content included in the input data is not valid based on a comparison of the content included in the input data to training content included in training data, stopping execution of the AI pipeline on the input data based on the input data not being valid, and presenting a notification via a graphical user interface (GUI) of the software application which indicates the input data is not valid. At least one portion of the example operation: integrates with an artificial intelligence (AI) chatbot, interacts with the AI chatbot, is performed by the AI chatbot, and/or is associated with an AI model.

### BACKGROUND

An artificial intelligence (AI) pipeline is a series of interconnected data processing and modeling steps designed to automate, standardize and streamline the process of building, training, evaluating and deploying AI models. An AI pipeline is a program that takes input and produces one or more predictive outputs. An AI pipeline can include a feature pipeline, a training pipeline, an inference pipeline, or the like. During an inference process, the AI pipeline receives input data, executes an AI model on the input data to generate output predictions (inferences). However, when the input data is incorrect, incomplete, not what the model is expecting, etc., the output is not reliable.

### SUMMARY

One example embodiment provides an apparatus that includes a memory configured to store an artificial intelligence (AI) model and a processor configured to perform one or more of integrate a trained AI model into an AI pipeline via a software application, receive input data via the software application and start execution of the AI pipeline on the input data, determine, during runtime of the AI pipeline, that content included in the input data is not valid based on a comparison of the content included in the input data to training content included in training data, stop execution of the AI pipeline on the input data based on the input data not being valid, and present a notification via a graphical user interface (GUI) of the software application which indicates the input data is not valid.

Another example embodiment provides a method that includes one or more of integrating a trained AI model into an AI pipeline via a software application, receiving input data via the software application and starting execution of the AI pipeline on the input data, determining, during runtime of the AI pipeline, that content included in the input data is not valid based on a comparison of the content included in the input data to training content included in training data, stopping execution of the AI pipeline on the input data based on the input data not being valid, and presenting a notification via a graphical user interface (GUI) of the software application which indicates the input data is not valid.

A further example embodiment provides a computer readable storage medium comprising instructions, that when read by a processor, cause the processor to perform one or more of integrating a trained AI model into an AI pipeline via a software application, receiving input data via the software application and starting execution of the AI pipeline on the input data, determining, during runtime of the AI pipeline, that content included in the input data is not valid based on a comparison of the content included in the input data to training content included in training data, stopping execution of the AI pipeline on the input data based on the input data not being valid, and presenting a notification via a graphical user interface (GUI) of the software application which indicates the input data is not valid.

One example embodiment provides an apparatus that includes a memory configured to store an artificial intelligence (AI) model and a processor configured to perform one or more of store a model of training data of the AI model in a storage of a software application, receive a request to execute an AI pipeline that includes the AI model on input data via the software application, determine that the input data is not valid data based on a comparison of the input data to the model of the training data, retrieve additional input data from the storage of the software application, determine that the additional input data is valid data based on a comparison of the additional input data to the model of the training data, and execute the AI pipeline that includes the AI model on the additional input data to generate a predictive output.

Another example embodiment provides a method that includes storing a model of training data of an artificial intelligence (AI) model in a storage of a software application, receiving a request to execute an AI pipeline including the AI model on input data via the software application, determining that the input data is not valid data based on a comparison of the input data to the model of the training data, retrieving additional input data from the storage of the software application, determining that the additional input data is valid data based on a comparison of the additional input data to the model of the training data, and executing the AI pipeline including the AI model on the additional input data to generate a predictive output.

A further example embodiment provides a computer readable storage medium comprising instructions, that when read by a processor, cause the processor to perform one or more of storing a model of training data of an artificial intelligence (AI) model in a storage of a software application, receiving a request to execute an AI pipeline including the AI model on input data via the software application, determining that the input data is not valid data based on a comparison of the input data to the model of the training data, retrieving additional input data from the storage of the software application, determining that the additional input data is valid data based on a comparison of the additional input data to the model of the training data, and executing the AI pipeline including the AI model on the additional input data to generate a predictive output.

One example embodiment provides an apparatus that includes a memory configured to store at least one artificial intelligence (AI) model and a processor configured to perform one or more of execute, via a software application, a predictive process on input data via an AI pipeline, wherein the AI pipeline comprises the at least one AI model and a model of training data for the at least one AI model, determine that the input data is not valid data based on a comparison of the input data to the model of the training data, pause execution of the predictive process by the AI pipeline on the input data based on the input data not being valid data, store an identifier of a location within the AI pipeline at which the execution of the predictive process is paused via the software application, retrieve new input data from a storage of the software application, modify the input data based on the new input data to generate modified input data, and resume execution of the predictive process on the modified input data at the location based on the identifier of the location stored in the storage of the software application.

Another example embodiment provides a method that includes one or more of executing, via a software application, a predictive process on input data via an artificial intelligence (AI) pipeline, wherein the AI pipeline comprises at least one AI model and a model of training data for the at least one AI model, determining that the input data is not valid data based on a comparison of the input data to the model of the training data, pausing execution of the predictive process by the AI pipeline on the input data based on the input data not being valid data, storing an identifier of a location within the AI pipeline at which the execution of the predictive process is paused via the software application, retrieving new input data from a storage of the software application, modifying the input data based on the new input data to generate modified input data, and resuming execution of the predictive process on the modified input data at the location based on the identifier of the location stored in the storage of the software application.

A further example embodiment provides a computer readable storage medium comprising instructions, that when read by a processor, cause the processor to perform one or more of executing, via a software application, a predictive process on input data via an artificial intelligence (AI) pipeline, wherein the AI pipeline comprises at least one AI model and a model of training data for the at least one AI model, determining that the input data is not valid data based on a comparison of the input data to the model of the training data, pausing execution of the predictive process by the AI pipeline on the input data based on the input data not being valid data, storing an identifier of a location within the AI pipeline at which the execution of the predictive process is paused via the software application, retrieving new input data from a storage of the software application, modifying the input data based on the new input data to generate modified input data, and resuming execution of the predictive process on the modified input data at the location based on the identifier of the location stored in the storage of the software application.

One example embodiment provides an apparatus that includes a memory configured to store an artificial intelligence (AI) model and a processor configured to perform one or more of execute an AI pipeline that includes the AI model via a software application, store a token data model of the AI model via a storage of the software application, receive input data via the AI pipeline of the software application, convert the input data into tokens via execution of a tokenizer within the AI pipeline on the input data, determine whether the tokenizer is valid based on a comparison of the tokens and the token data model of the AI model, and continue execution of the AI pipeline of the software application based on whether the tokenizer is valid.

Another example embodiment provides a method that includes one or more of executing an artificial intelligence (AI) pipeline including an AI model via a software application, storing a token data model of the AI model via a storage of the software application, receiving input data via the AI pipeline of the software application, converting the input data into tokens via execution of a tokenizer within the AI pipeline on the input data, determining whether the tokenizer is valid based on a comparison of the tokens and the token data model of the AI model, and continuing execution of the AI pipeline of the software application based on whether the tokenizer is valid.

A further example embodiment provides a computer readable storage medium comprising instructions, that when read by a processor, cause the processor to perform one or more of executing an artificial intelligence (AI) pipeline including an AI model via a software application, storing a token data model of the AI model via a storage of the software application, receiving input data via the AI pipeline of the software application, converting the input data into tokens via execution of a tokenizer within the AI pipeline on the input data, determining whether the tokenizer is valid based on a comparison of the tokens and the token data model of the AI model, and continuing execution of the AI pipeline of the software application based on whether the tokenizer is valid.

### BRIEF DESCRIPTION OF DRAWINGS

FIG. 1 is a system diagram illustrating an AI operational pipeline according to examples and features of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIGS. 3A-3C are diagrams illustrating a training process performed via an operational pipeline according to examples and features of the instant solution.

FIGS. 4A-4E are diagrams illustrating a process of resolving missing data during an inference performed by an AI pipeline according to examples and features of the instant solution.

FIGS. 5A-5C are diagrams illustrating a process of pausing an AI pipeline and

resuming the AI pipeline after fixing the input data according to examples and features of the instant solution.

FIGS. 6A-6B are diagrams illustrating a process of validating a tokenizer of an AI operational pipeline according to examples and features of the instant solution.

FIGS. 6C-6D are diagrams illustrating a process of validating embeddings of a transformer of the AI operational pipeline according to examples and features of the instant solution.

FIGS. 7A-7B are diagrams illustrating a method of detecting invalid input data during runtime of an AI pipeline according to examples and features of the instant solution.

FIGS. 8A-8B are diagrams illustrating a method of correcting invalid input data during runtime of an AI pipeline according to examples and features of the instant solution.

FIGS. 9A-9B are diagrams illustrating a method of pausing an AI pipeline when invalid data is detected and resuming the AI pipeline from the paused location according to examples and features of the instant solution.

FIGS. 10A-10B are diagrams illustrating a method of validating a tokenizer of an AI pipeline according to examples and features of the instant solution.

FIG. 11 is a system diagram illustrating a computing environment according to the instant solution's example features, structures, or characteristics.

### DETAILED DESCRIPTION

The examples and features of the instant solution are directed to a unified framework that can be used to enhance the reliability of artificial intelligence (AI) or machine learning (ML) operational pipelines through various validations. The framework may include a toolkit (e.g., a software library, etc.) which includes functions for validating input data against historical data, validating a tokenizer, validating embedded data, validating output data, and the like. In some examples and features of the instant solution, the toolkit may be a software library implemented in a common programming language, however, the examples and features of the instant solution are not limited thereto.

An AI pipeline may be used for training an AI model. As another example, an AI pipeline may be used for generating an inference (e.g., a predictive output) from input data based on execution of a trained AI model on the input data. Traditionally, data input to an AI/ML pipeline is generally assumed to be valid data. For example, once the input data is tokenized, the input data is assumed to be valid. But there may be inconsistencies and errors present within the input data even after tokenization. In some cases, these anomalies may be the result of the input data not being the expected data (e.g., mortgage data when the model is trained on credit card data, etc.) As another example, the anomalies may be the result of a tokenizer not creating the proper tokens from the input data. When the input data is invalid and the pipeline is executed, the resources for executing the pipeline on the invalid input data are wasted because the results are usually invalid.

In the examples and features of the instant solution, the framework may detect invalid input data (e.g., invalid tokenized data) during execution of the AI pipeline and may stop/pause the AI pipeline. In some cases, the framework may flag a location at which the AI pipeline is stopped. Furthermore, the framework may obtain correct/valid input data and resume the AI pipeline from the location at which it was stopped, thereby preventing resources from being wasted. That is, the steps of the pipeline that have already been performed prior to the pause can be preserved and later reused when the pipeline is resumed. The framework may be used for both distributed data sets and non-distributed data sets. Furthermore, the framework may provide unified tools such as tokenization validation, automation partition columns, date format transformations, data range specifications, and the like.

The validation process may be performed during runtime of the AI pipeline. For example, parts of the pipeline such as data ingestion, parsing, cleaning, and tokenization may be performed prior to the validation process. In some cases, the validation process may be performed before the data has been input to an AI model integrated within the AI pipeline. As another example, the validation process may be performed after the data has been output by the AI model. When the data is unable to be validated, the AI pipeline may be stopped, and the data may be fixed. After fixing the data, the pipeline may be resumed from the location at which it was stopped.

The instant solution introduces a technical improvement in the operation of computer systems by advancing the management and execution of artificial intelligence (AI) operational pipelines. This improvement is centered on enhancing the reliability and efficiency of data processing within AI models, ensuring that computer systems can perform complex tasks with greater accuracy and resource optimization.

Computer systems often encounter challenges when processing large datasets through AI models, particularly when the input data is incomplete, improperly formatted, or otherwise invalid. Traditional approaches to AI pipeline management may lead to the processing of such data, resulting in erroneous outputs and unnecessary consumption of computational resources. The instant solution addresses these issues by implementing an advanced real-time data validation mechanism that operates throughout the pipeline's runtime. This mechanism continuously monitors the input data, comparing it against predefined models and expected formats to detect any anomalies or inconsistencies.

When invalid data is detected, the solution has the capability to pause the AI pipeline, preventing further processing of faulty data. The system then retrieves or generates the necessary corrective data, ensuring that the pipeline can resume operations without the need to restart the entire process. This not only conserves computational resources but also significantly reduces the time and energy required to complete AI-driven tasks.

The introduction of these validation and correction processes within the AI pipeline represents a technical improvement for computer systems. By ensuring that only valid data is processed, the solution enhances the accuracy of AI models, leading to more reliable and meaningful outputs. Additionally, the ability to dynamically manage pipeline execution reduces the computational burden on the system, resulting in optimized performance and extended system longevity.

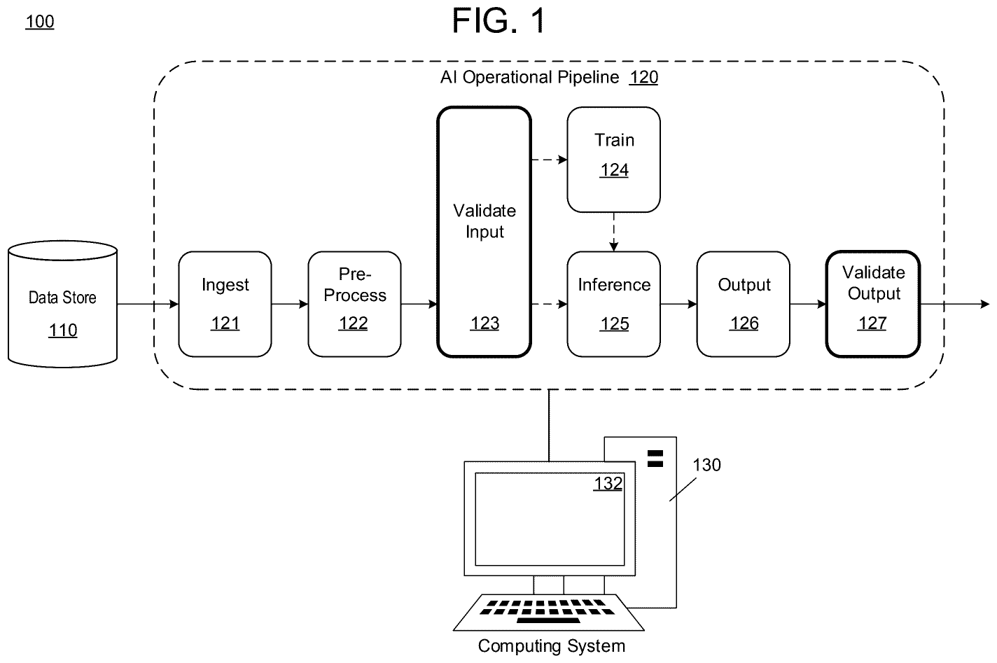

FIG. 1 illustrates a process 100 of executing an AI operational pipeline 120 according to examples and features of the instant solution. Referring to FIG. 1, the AI operational pipeline 120 may be integrated within a software application (e.g., framework) that is hosted by a host platform such as a cloud platform, a web server, a local machine, or the like. A computing device 130 may connect to the software application and create, execute, and rerun the AI operational pipeline 120 based on commands that are entered via a graphical user interface (GUI) 132 of the computing device. Here, the computing device 130 may connect to the host platform over a computer network such as the Internet and access the software application through a browser, a progressive web application, a mobile application, or the like.

The computing device 130 may request execution of the AI operational pipeline 120 on input data. In this example, the input data is ingested by an ingest module 121 of the AI operational pipeline 120 from an input data store 110. There may be multiple different input data sources, however, for convenience a single input data source is shown. The ingested input data may include tabular data that includes a plurality of columns and a plurality of rows, such as a comma-separated values (CSV) file, spreadsheet, text file, word processing file, or the like. As another example, the ingested data may include image data, audio data, numerical data, text data, or the like.

The AI operational pipeline 120 includes a pre-process module 122 which may perform various steps on the input data, for example, identifying missing values (e.g., null values, etc.) within the input data. The missing values may be inferred from other values in the table, or the column/row of null values may be deleted. As another example, the pre-process module 122 may encode data values within the input data, identify and remove outliers that can skew the predictive output from the input data, split the data set into a training set and a test set, resampling, standardization, normalization, and the like.

In addition, the pre-process module 122 may perform a tokenization process on the input data which converts the input data to tokens. Here, the tokens may be smaller pieces of text (chunks) from a larger set of text. In some examples and features of the instant solution, the tokenizer may convert the small pieces of text into numerical values that can be processed by the AI model. Here, the tokenizer may assign a unique ID (number) to each different piece of text/token included in the input data that represents the text as a number.

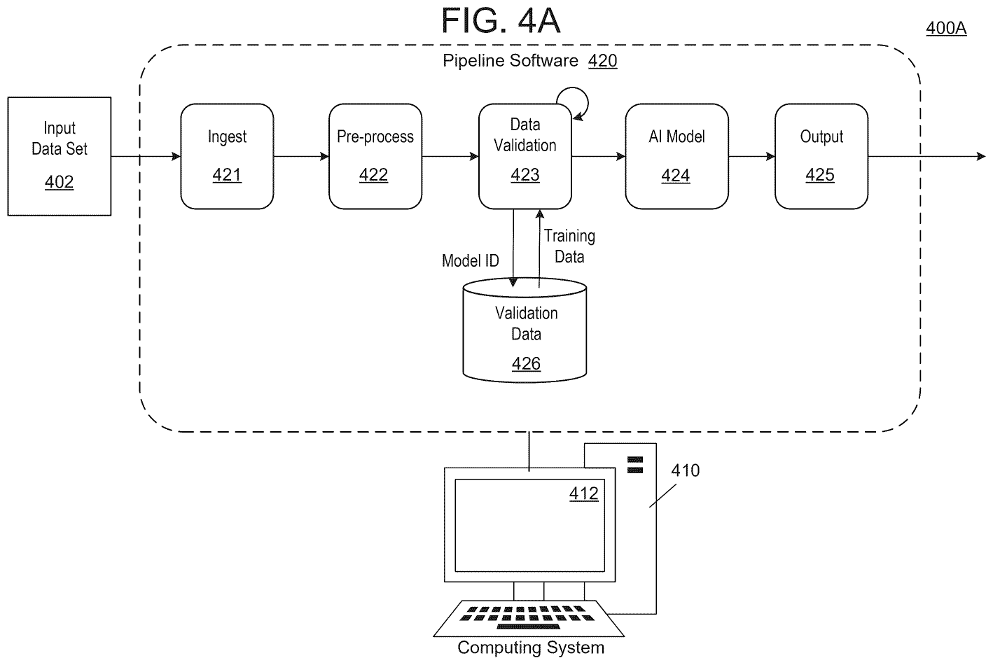

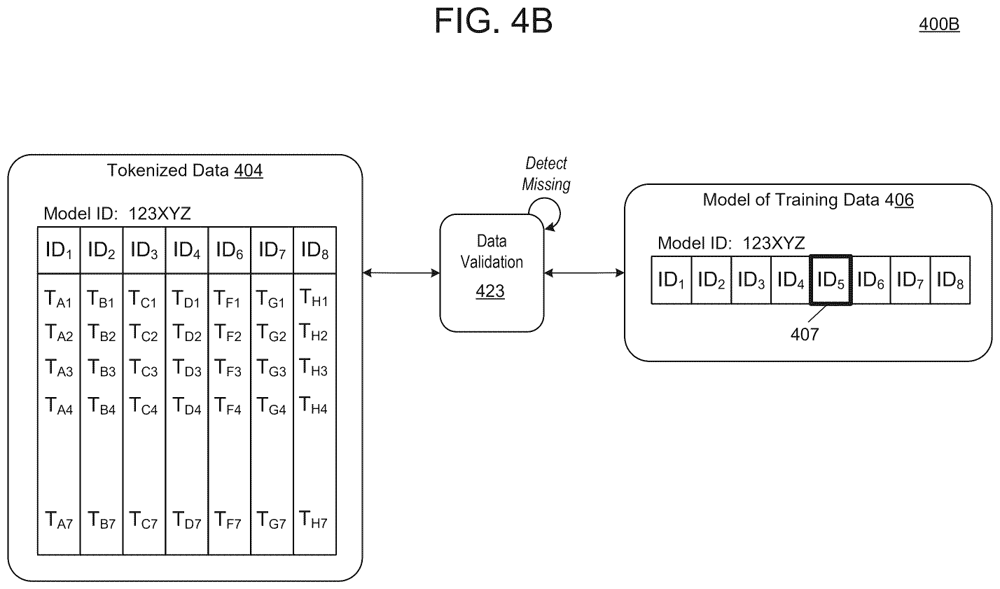

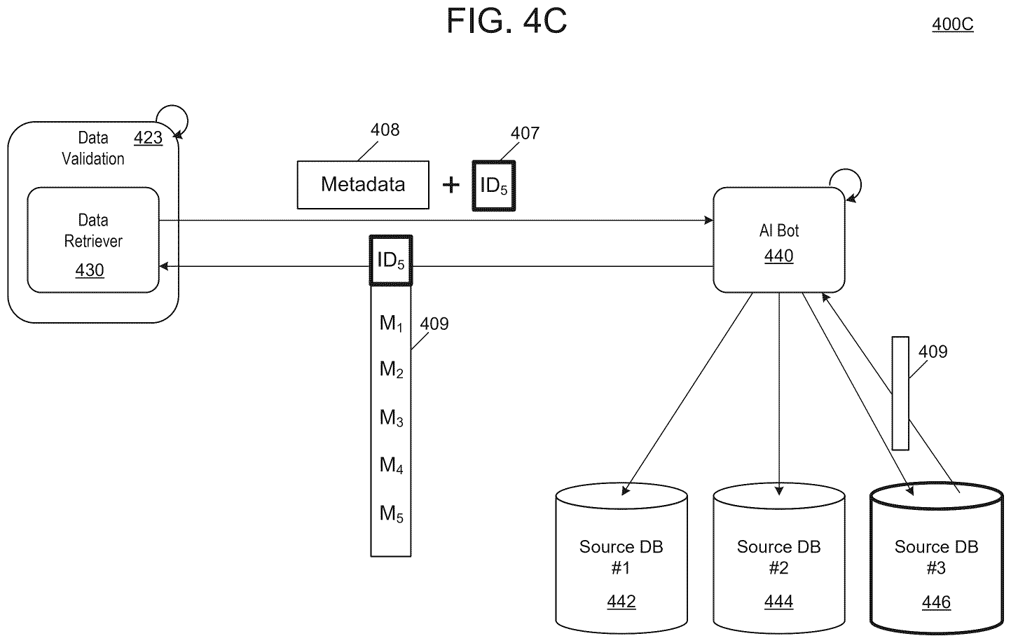

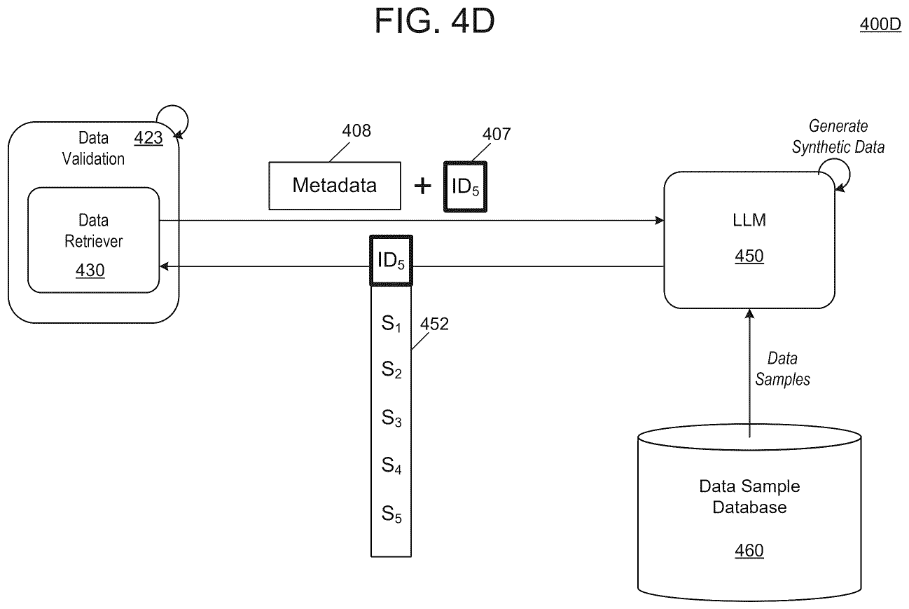

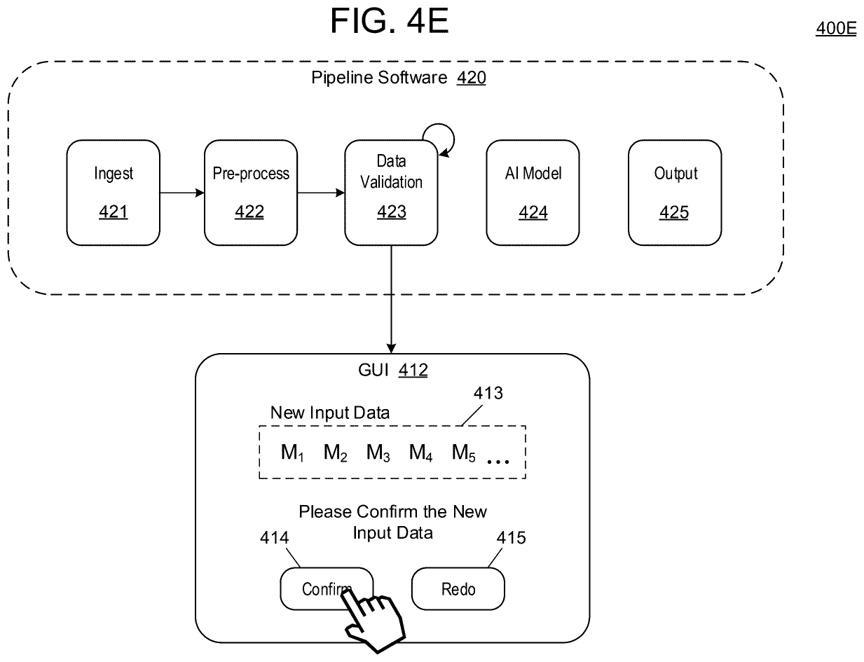

According to various examples and features of the instant solution, the tokenized input data may be validated by a validate input module 123. Here, the validate input module 123 may compare the tokenized input data to an expected format that the AI model is expected. The expected format may be referred to as a model. The model may be determined/created during training of the AI model and may include number of columns, number of tokens, number of variables, token sizes, etc. that are expected. As further discussed in the examples of FIGS. 4A-4E, when the tokenized data is determined to be invalid, the AI operational pipeline 120 can be paused, and the invalid data can be fixed.

After the validation process has finished, the validated tokenized input data may be used to train 124 a model or an inference 125 (e.g., prediction) by execution of an AI model on the valid tokenized input data. The result of the execution of the AI model is an output 126 that can also be validated by a validate output module 127. Here, the validate output module 127 may determine whether the output data adheres to an expected format, data type, range of values, and the like.

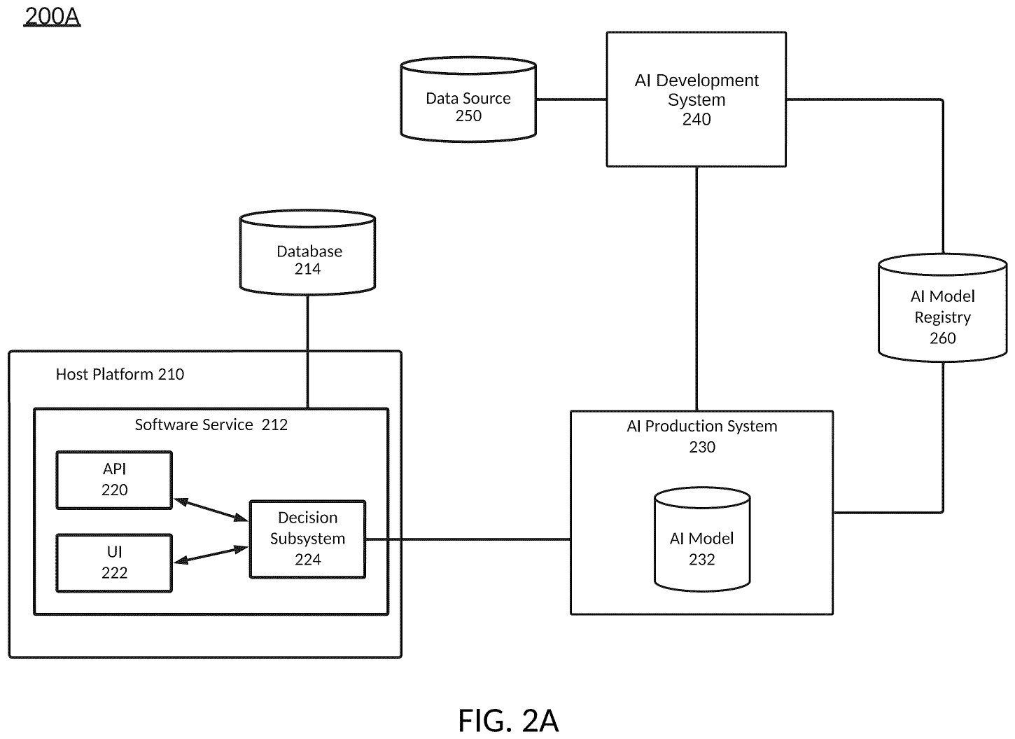

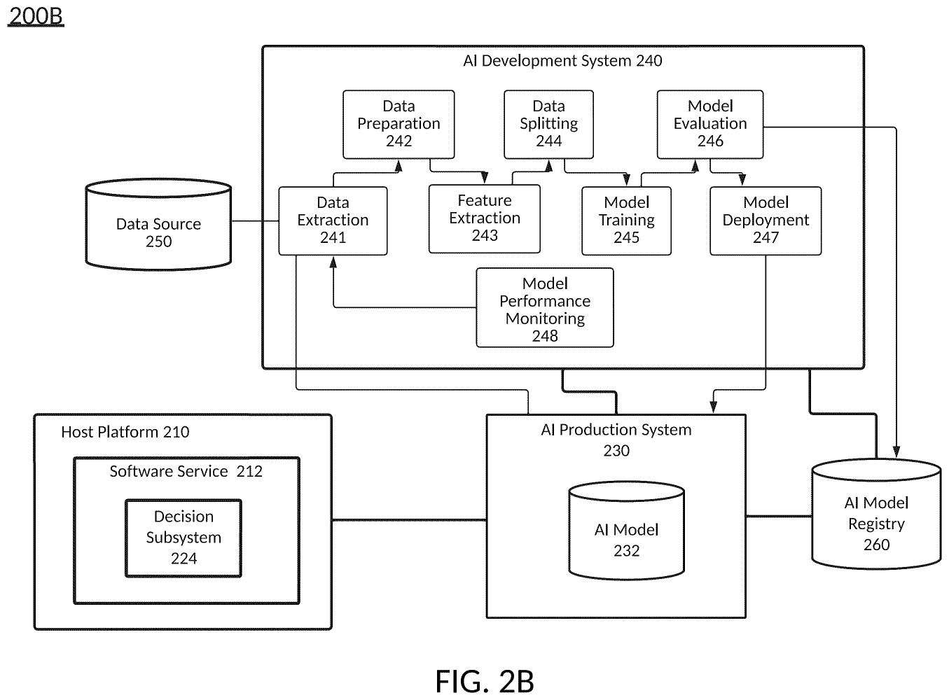

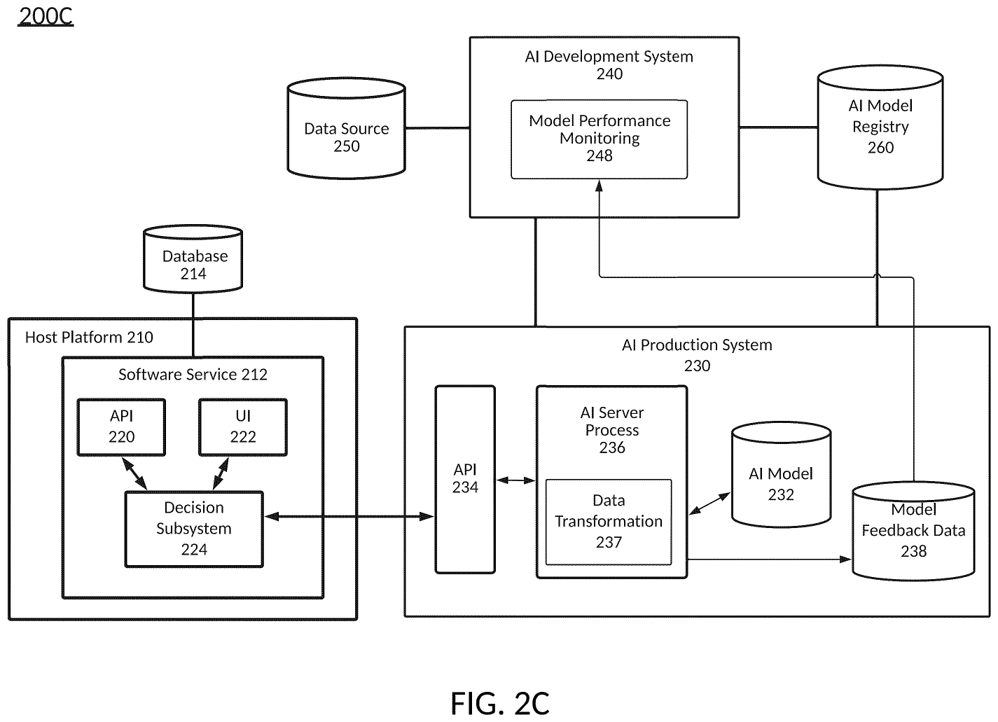

FIG. 2A illustrates an artificial intelligence (AI) network diagram 200A that supports AI-assisted decision points in a software service executing on a computer. One or more computing devices and a host platform 210 may communicate via a network. The host platform 210 may host a software service 212. The software service 212 may communicate with one or more databases 214 through a network during the course of service execution. In some examples and features of the instant solution, a computing device may host a service client which communicates with a corresponding software service 212.

A computing device may be a mobile phone, tablet, laptop computer, desktop computer, smartwatch, vehicle infotainment system, or any computing device including a processor and memory. The host platform 210 may include a single physical server, multiple physical servers, a cloud hosting environment, or a hybrid hosting environment in which some components of the host platform 210 are “on-premise” while others are cloud-hosted. The network is a computer network and may include one or more interconnected computer networks. For example, network may be or may include an Ethernet network, an asynchronous transfer mode (ATM) network, a wireless network, a telecommunications network or the like.

The software service 212 provides the service logic. It may provide one or more Application Programming Interfaces (APIs) for communicating with one or more service clients. A “thick” user interface client that runs on a computing device may utilize the APIs to communicate with the software service 212. Further, the software service 212 may provide hosted User Interfaces (UIs) that can be accessed through browser-based software on some computing devices.

The one or more service clients can enable service access for end users and may come in a variety of forms including, but not limited to, a mobile device application (“app”) or a web portal accessed via a browser on a computing device such as a laptop or desktop computer.

Detailed descriptions of the software architecture for offering different transactions and for dynamically offering products during an ongoing communication session in the instant solution are further described and depicted herein.

While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

In the example of FIG. 2A, the software service 212 executing on host platform 210 may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 212 to assist in decision-making. In some examples and features of the instant solution, the software service 212 stores data included in API requests or data generated during processing the API requests into one or more databases 214.

Software service 212 may provide one or more user interfaces (UIs) 222, such as a server-side hosted GUI. In some examples and features of the instant solution, the UIs 222 provided employ template-based frameworks, component-based frameworks, etc. In some examples and features of the instant solution, these UIs 222 send data to one or more decision subsystems 224 of the software service 212 to assist with decision-making. In some examples and features of the instant solution, the software service 212 stores data included in UI requests or data generated during processing the UI requests into one or more databases 214.

Software service 212 may include one or more decision subsystems 224 that drive a decision-making process of the software service 212. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 212, UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and the operation of the AI production system and its components.

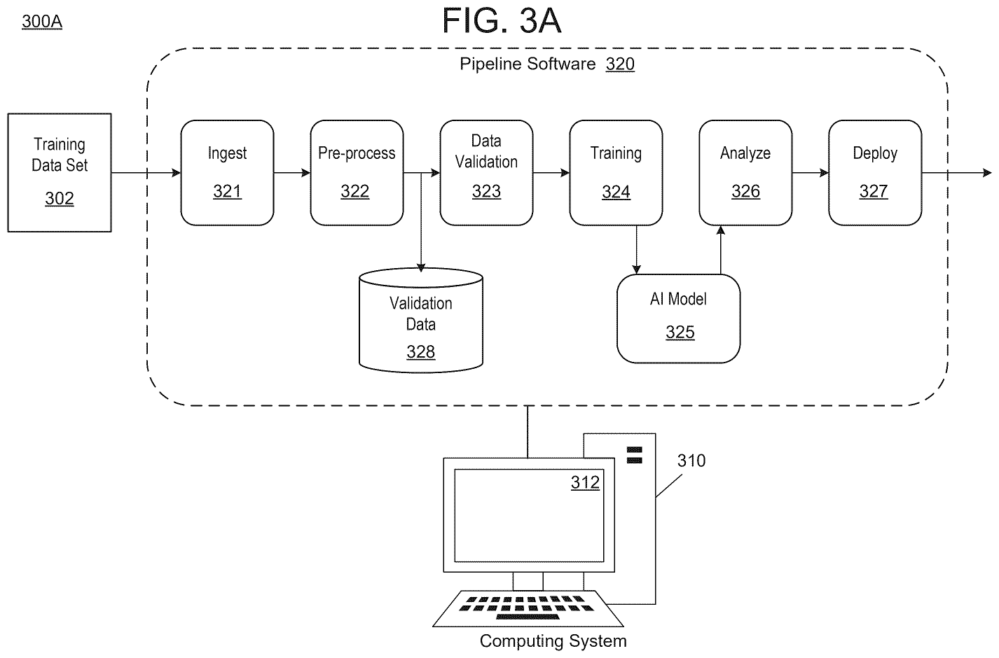

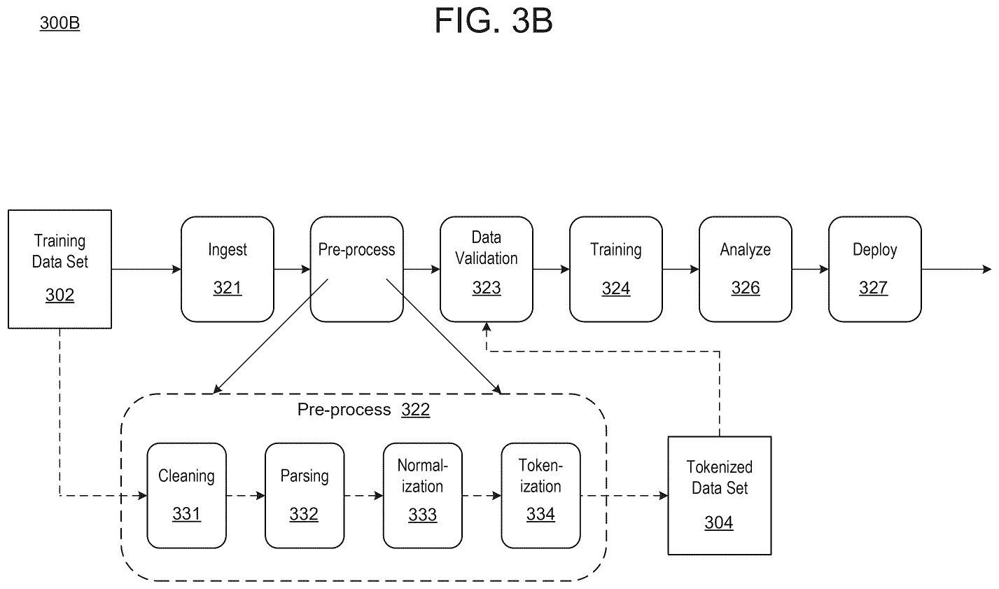

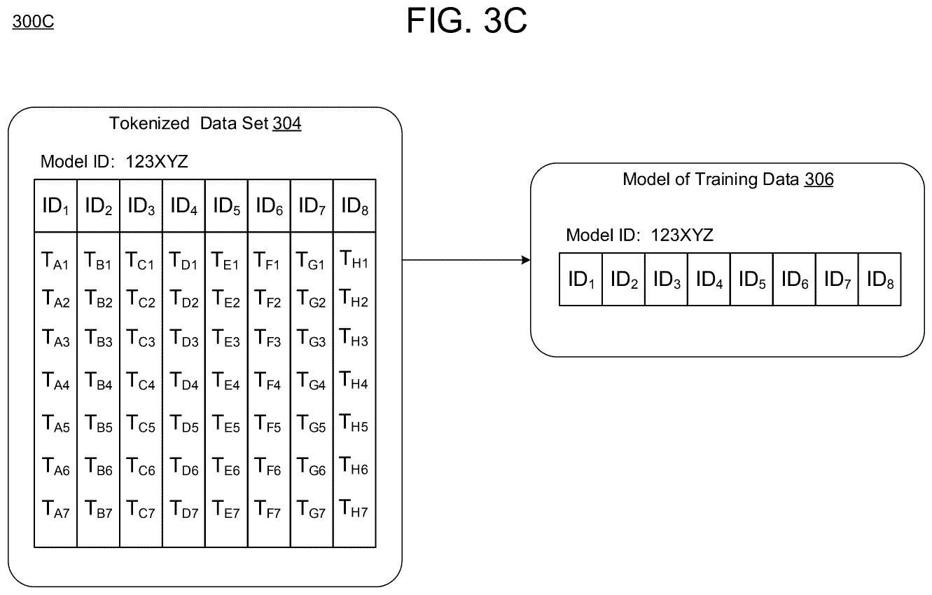

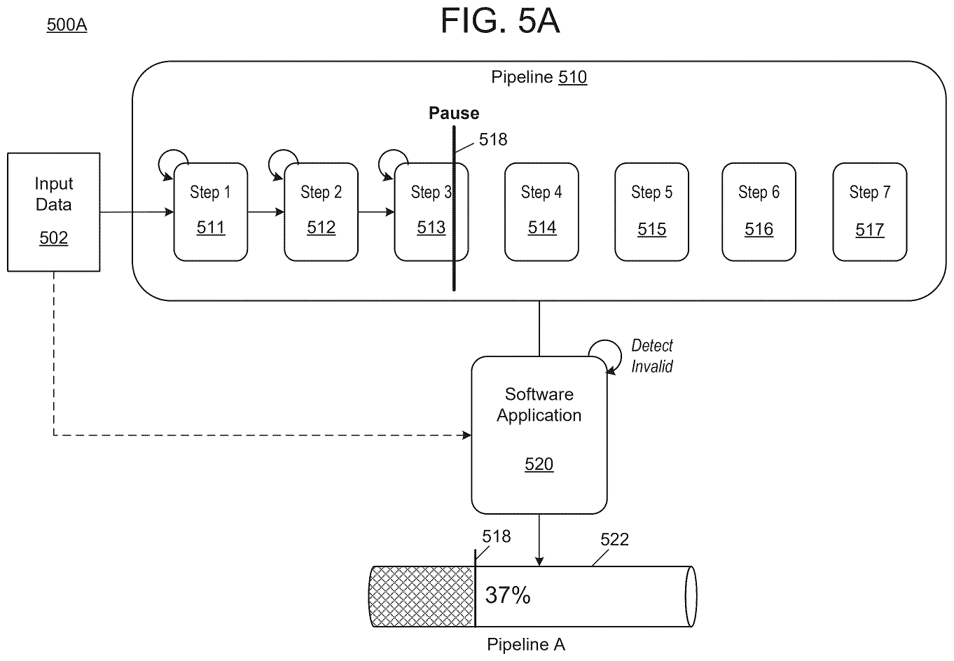

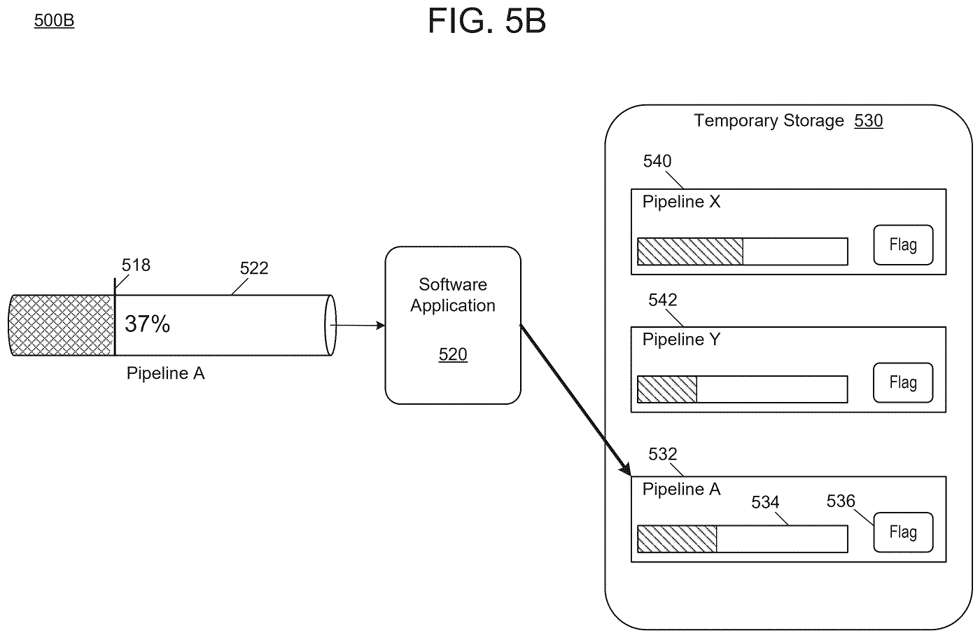

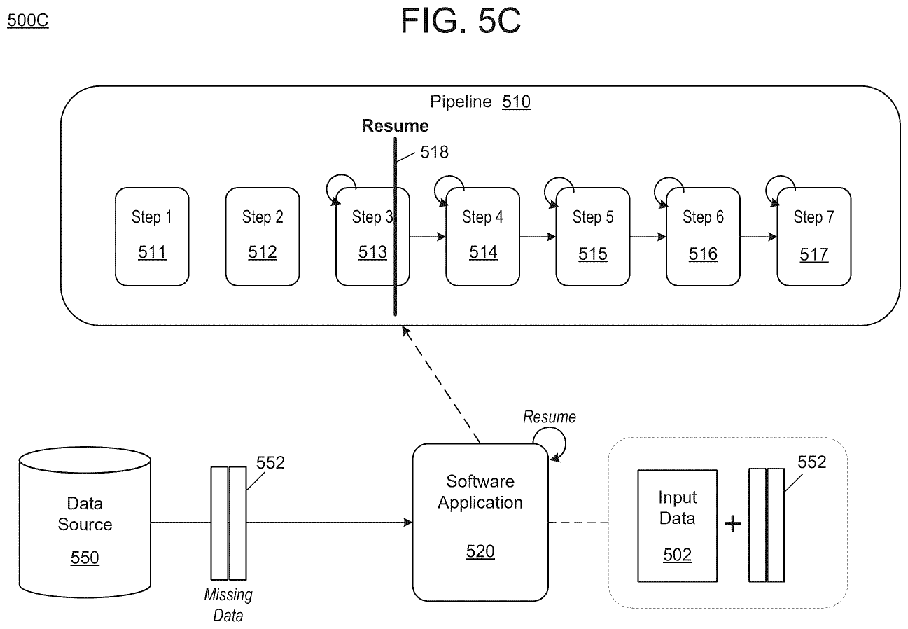

In the examples and features of the instant solution, the pipelines described and depicted, such as AI operational pipeline 120 in FIG. 1, pipeline software 320 in FIGS. 3A-3C, pipeline software 420 in FIGS. 4A-4E, and pipeline 510 in FIGS. 5A-5C, are examples of AI development system 240 described and depicted in FIGS. 2A-2C.

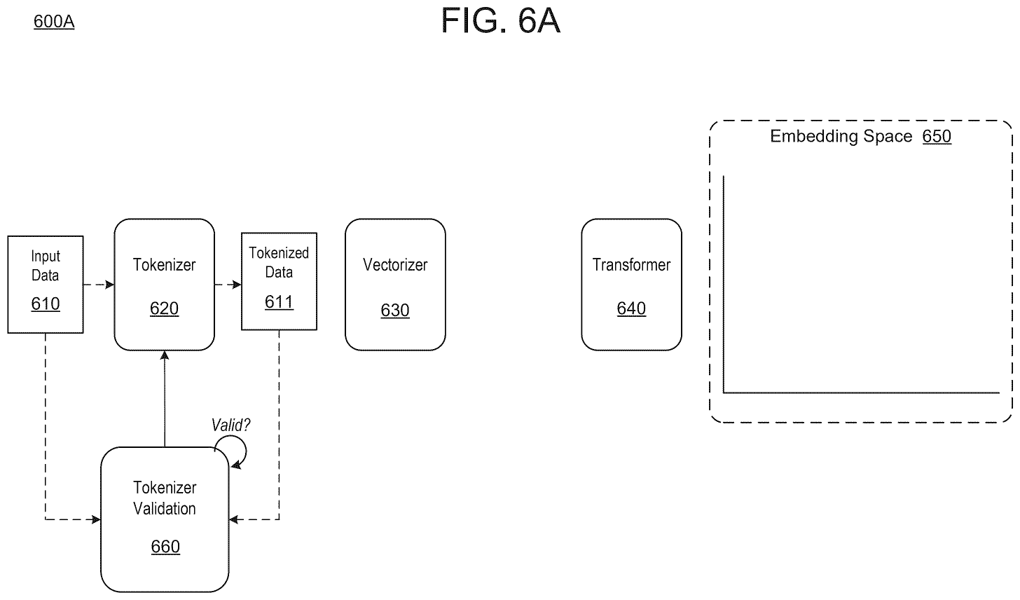

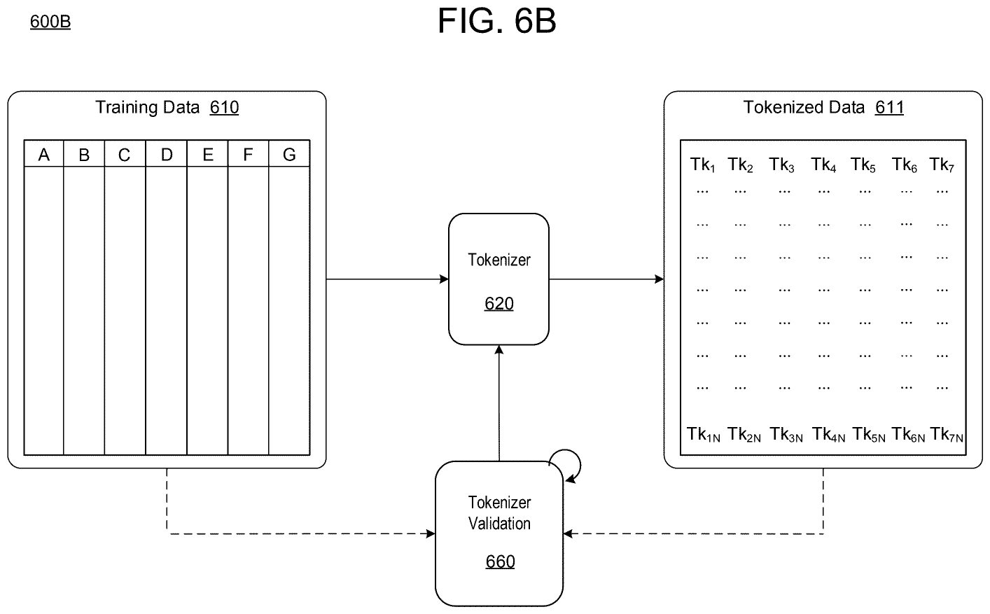

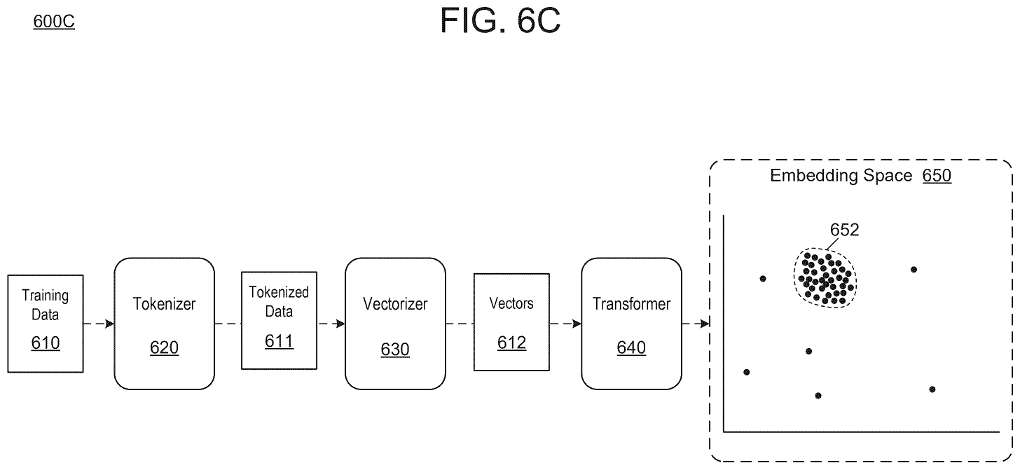

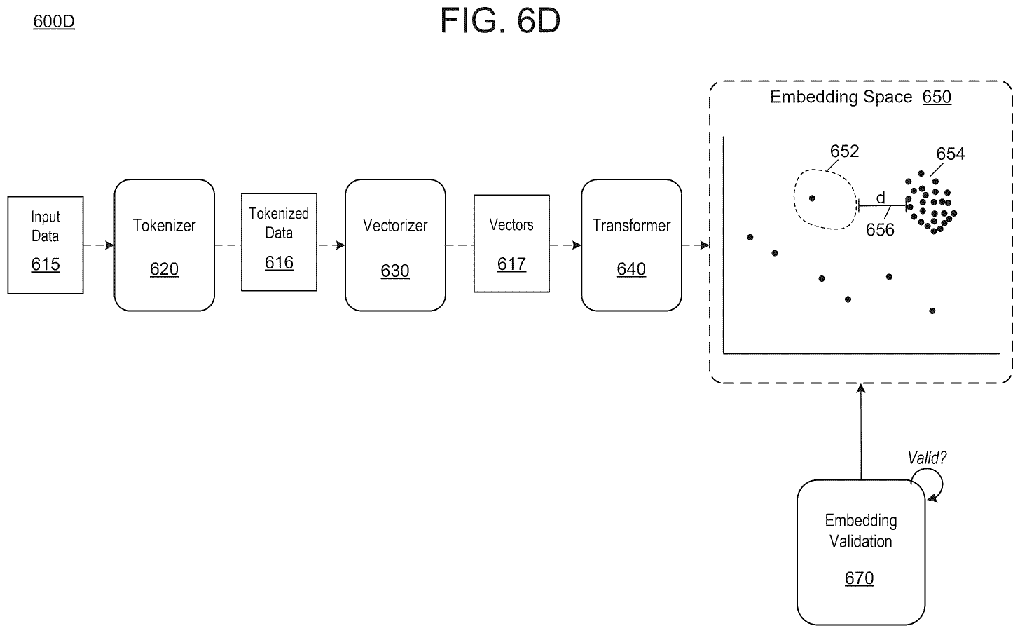

In the examples and features of the instant solution, the data sources for the pipelines described and depicted, such as data store 110 in FIG. 1, training data set 302 in FIGS. 3A-3C, input data set 402 in FIGS. 4A-4E, input data 502 in FIGS. 5A-5C, and input data 610 and 615 in FIGS. 6A-6D, may be examples of data source 250 described and depicted in FIGS. 2A-2C.

According to various examples and features of the instant solution, an artificial intelligence operational pipeline (e.g., an AI pipeline) may be used to train an AI model by executing the AI model on training data. The AI pipeline may include various modules, nodes, etc. which perform various tasks of the AI pipeline. The tasks may be executed in sequence. As another example, the tasks may be executed in parallel. In addition to training an AI model, the AI pipeline may be used to perform an inference (e.g., generate a predictive output) by executing the AI model on input data.

According to various examples and features of the instant solution, the AI pipeline may validate the training data, the input data, the output data, and the like. For example, when the input data is determined to be invalid, the software may pause/stop the AI pipeline and flag a location (e.g., a point in the process, etc.) at which the process is stopped. Furthermore, the software may replace or otherwise fix the invalid data with valid data and resume the AI pipeline from the flagged location in the process.

FIGS. 3A-3C illustrate a training process performed via an operational pipeline according to examples and features of the instant solution. The training process and the operational pipeline described and depicted in FIGS. 3A-3C are the basis for the examples further described and depicted in FIGS. 4A-4E and FIGS. 5A-5C.

For example, FIG. 3A illustrates a process 300A of executing the AI pipeline on training data set 302 to train an AI model 325 which is an example of AI model 232 (see, for example, FIGS. 2A-2C). In some examples and features of the instant solution, the AI model 325 may be integrated into the pipeline (or another pipeline) and used for making inferences on runtime data input to the pipeline.

Referring to FIG. 3A, a host platform (not shown) such as a web server, a cloud platform, a combination of systems, and the like, may host pipeline software 320 which can launch, execute, and terminate AI pipelines. In some cases, the software can launch multiple pipelines at the same time, however, for purposes of explanation, a single pipeline is shown. Referring to FIG. 3A, the pipeline software 320 includes an ingest module 321, a pre-process module 322, a data validation module 323, a training module 324, an analyze module 326, and a deploy module 327. The ingest module 321 is an example of data extraction 241 (see, for example, FIG. 2B). The pre-process module 322 and data validation module 323 are examples of data preparation 242, feature extraction 243, and data splitting 244 (see, for example, FIG. 2B). The training module 324 is an example of model training 245 (see, for example, FIG. 2B). The analyze module 326 is an example of model evaluation 246 (see, for example, FIG. 2B). The deploy module 327 is an example of model deployment 247 (see, for example, FIG. 2B). Here, a computing device 310 may connect to the pipeline software 320 and trigger execution of an AI model by inputting commands through a GUI 312 of the computing device 310.

In operation, the ingest module 321 may ingest training data set 302 from one or more data sources such as databases, data stores, or the like. In some examples and features of the instant solution, the training data set 302 may be ingested via one or more application programming interfaces (APIs) which are not shown. The training data set 302 may be in tabular format. As another example of the instant solution, the training data set 302 may be image data, text data, audio data, or the like, and may be converted into table data by the pre-process module 322. The pre-process module 322 may clean the data, transform the data, and prepare the data for input to the AI model. The transformation process may include tokenizing the data. In some examples and features of the instant solution, the transformation process may also include vectorizing the tokenized data and embedding the vectorized data into an embedding space. The vectorizing and embedding process may be performed by a neural network (not shown) such as a transformer network.

The data validation module 323 may identify a data model of the training data set 302 and record the data model of the training data set within a validation data storage 328 of the software. The data model may include an identifier of the columns, the variables, the token count, and the like. In some examples and features of the instant solution, the data model may include a model of the raw training data. As another example, the data model may include a model of the tokenized data. The data model may be stored along with an identifier of the AI model that is being trained by the AI model 325.

The AI model 325 may be trained by a training module 324 such as an AI execution engine, or the like. The training module 324 may execute the AI model 325 on the training data set 302 (e.g., that has been pre-processed). The output of the training module 324 may include a predicted output. The analyze module 326 may compare the predicted output to an expected output to determine an accuracy of the AI model 325. In some examples and features of the instant solution, the results of the training may be displayed on the GUI 312 of the computing device. Here, a user may verify the accuracy of the training and determine whether to continue or stop the training. As another example of the instant solution, the training module 324 may automatically continue executing the training process until a stop condition is reached, such as a number of executions, a predetermined accuracy, a time limit, or the like. When the AI model 325 is fully trained, the AI pipeline software may deploy the AI model 325 via a deploy module 327. The deploy module 327 may integrate the AI model 325 into an AI pipeline.

FIG. 3B illustrates a process 300B of the pre-process module 322 converting the training data set 302 into tokenized data set 304 according to various examples and features of the instant solution. Referring to FIG. 3B, the pre-process module 322 may perform multiple steps on the training data set 302 including a cleaning module 331, a parsing module 332, a normalization module 333, a tokenization module 334, and the like. In this example of the instant solution, the cleaning module 331 may include detecting and removing outliers from the training data set 302, identifying missing values, removing duplicate values, and the like. The parsing module 332 may include identifying parts of speech within a larger set of text or the like. The normalization module 333 may be performed on the training data set 302 to translate the data into a different value. The tokenization module 334 may convert the training data set 302 into tokens and store the tokens within a tokenized data set 304.

FIG. 3C illustrates a process 300C of generating a model of the training data 306 from the tokenized data set 304 according to examples and features of the instant solution. Referring to FIG. 3C, the pipeline software 320 shown in FIG. 3A may create the model of the training data 306 based on the columns included in the tokenized data set 304. Here, the model of the training data 306 may include a column count (of tokenized data), identifiers of the columns, a total number/amount of tokens in the tokenized data set 304, a size of the tokens, and the like. The model of the training data model training data 306 may be written to the validation data storage 328 and referred to for future validations of the AI pipeline.

FIGS. 4A-4E are diagrams illustrating a process of resolving missing data during an inference performed by an AI pipeline according to examples and features of the instant solution. In the examples and features of the instant solution, the system described herein may detect that the input data is invalid and correct the input data by retrieving additional data that resolves the invalidity of the input data. For example, an AI model may be trained on a first type of data such spending data of customers. When the AI model receives a different type of data during live execution (such as savings account data), the AI model may not perform well on the incorrect data. According to various aspects, the AI pipeline software may detect this mismatch of data (invalid data) and correct the mismatch with the correct data expected by the AI model.

For example, when performing an inference process, an AI pipeline may integrate the AI model therein and may ingest input data during runtime. Here, the AI model is expecting the input data to be spending data. When the AI pipeline software detects that the input data is not spending data (e.g., it is some other kind of data such as credit card account data, mortgage data, loan data, etc.), the AI pipeline software can detect which columns of data in the raw data are invalid (not expected by the AI model) and remove them. The detection process may be performed based on a format of the data (e.g., number of columns, tokens, column headers, etc.), a storage location from which the input data is retrieved, and the like. For example, when the training data is held in a first storage location and the new input data is from a second storage location, the two storage locations may differ in what data is stored and/or how the data is stored. In addition, the AI pipeline software can retrieve missing columns of data that the AI model is expecting. For example, the AI pipeline software can retrieve the missing columns of data from existing data already held by the organization, for example, from one or more data sources. As another example of the instant solution, the AI pipeline software can generate synthetic data that matches the criteria of the missing columns of data.

In one example of the instant solution, the AI operational pipeline is used within a software application hosted on a host platform, such as the one illustrated in FIG. 2A. The data pipeline is configured to receive data from an input data store through an ingest module, which serves as the data access point for incoming production data. Upon receiving the first set of production data, the system determines a first ancillary data from this initial dataset. The determined ancillary data is then tokenized using a tokenizer component within the pre-process module, converting the data into a format suitable for further processing by the AI model.

Subsequently, a second set of production data is received via the same data access point. The system again determines ancillary data from this second dataset. During this process, the software application, which is executing the AI operational pipeline, assesses whether the second set of ancillary data indicates any invalid data. When invalid data is detected, the system inserts a flag in the data pipeline to mark this occurrence. In response to determining the presence of invalid data, the system performs at least one of the following actions: presenting an alert via a GUI of the software application, logging the alert for record-keeping, stopping the data pipeline to prevent further processing of invalid data, restarting the data pipeline after addressing the issue, skipping the second set of production data when it cannot be corrected, fixing errors in the second set of production data, resuming the data pipeline from the flagged location, or modifying the second set of production data to correct the invalid entries.

FIG. 4A illustrates a process 400A of ingesting raw data via an AI pipeline and validating an input data set 402 via pipeline software 420 according to examples and features of the instant solution. Referring to FIG. 4A, a host platform (not shown) such as a web server, a cloud platform, or the like, may host pipeline software 420. A computing device 410 may connect to the host platform via a computer network, such as the Internet, by entering a web address, IP address, or the like, of the pipeline software 420 into a browser. As another example of the instant solution, the pipeline software 420 may be a mobile application, a progressive web application (PWA), or the like. In this example, the computing device 410 connects to the host platform and launches an AI pipeline including an AI model 424, which may be an example of AI model 232 (see, for example, FIGS. 2A-2C), for the purpose of generating a predictive output (inference) on the input data set 402. Here, commands may be entered on a display screen of the computing device 410 which includes a GUI 412 of the pipeline software 420. The commands may launch the AI pipeline including a model that is selected via the GUI 412.

According to various examples and features of the instant solution, the input data set 402 may be chosen based on commands entered via the GUI 412. In response, the pipeline software 420 may retrieve the input data set 402 from one or more data sources (not shown) where the input data set 402 is stored such as a local drive, an external database, or the like. The input data set 402 may refer to table data, text data, image data, audio data, or the like. Here, an ingest module 421 may ingest the input data set 402 from its storage location and transfer the input data set 402 to a pre-process module 422 which may clean the data, normalize the data, remove null values, etc. In addition, the pre-process module 422 may also transform the input data into tokens through a tokenization process that is performed by a tokenizer. The tokenized data may be provided from the pre-process module 422 to a data validation module 423. In this example of the instant solution, the data validation module 423 may retrieve training data of the AI model 424 from a validation data storage 426. The training data may be identified using an identifier of the AI model 424 such as a name, a unique identifier, a timestamp of the creation of the AI model 424, and the like. Here, the data validation module 423 may validate the input data set 402 based on the training data of the AI model 424 which is retrieved from the validation data storage 426. Referring to FIG. 4A, the ingest module 421 is an example of data extraction 241 (see, for example, FIG. 2B). The pre-process module 422 and data validation module 423 are examples of data preparation 242, feature extraction 243, and data splitting 244 (see, for example, FIG. 2B).

FIG. 4B illustrates an example of a validation process 400B that is performed by the data validation module 423. Referring to FIG. 4B, the input data set 402, shown in FIG. 4A, may be converted into tokenized data 404 by the pre-process module 422, which is an example of pre-process module 322 (see, for example, FIG. 3B), using any of the pre-process module steps previously mentioned including cleaning, normalization, vectorization, tokenization, and the like. Here, the tokenized data 404 includes tokens that have been generated from the raw data and metadata of the raw data including column numbers, token counts, token sizes, and the like. The data validation module 423 may compare the tokenized data 404 to a model of the training data 406 of the AI model 424. Here, the model of training data 406 may correspond to the model of training data 306 generated in the process shown in FIG. 3C, however, examples and features of the instant solution are not limited thereto.

In this example of the instant solution, the data validation module 423 determines that the tokenized data 404 is missing a column of data 407 based on a comparison of the metadata of the tokenized data 404 to the model of training data 406. The tokenization process may remove the columns and keep rows of tokenized values. However, the number of columns and the type of data included in the columns can be determined from the metadata. For example, when the tokenized data includes rows of seven tokens, but the model of the training data 406 includes eight columns, the data validation module 423 can determine that a token value is missing from each row and that an eighth token is expected to make the input data valid.

Although not shown in FIG. 4B, the data validation module 423 may determine that the tokenized data 404 includes too many columns of tokens, or different tokens than expected, and may remove one or more columns of tokens through a similar process. The removal may include removing a column, a token, multiple tokens, etc.

In addition to detecting the missing data from the input data set 402, the data validation module 423 may also retrieve new input data which can be used to modify the input data thereby creating valid input data. In some cases, the input data may be retrieved from existing data already held in storage. As another example of the instant solution, the input data may be created synthetically.

FIG. 4C illustrates a process 400C of retrieving new input data from among existing data already stored in one or more databases such as source databases 442, 444, and 446. Referring to FIG. 4C, the data validation module 423 may include a data retriever module 430 that can query an AI bot 440 with an identifier of the missing column of data 407 as well as identifiers of the columns of data that are present. In some examples and features of the instant solution, the data retriever module 430 may also provide metadata 408 associated with the missing column of data 407 which may be embedded within the input data set 402, such as within a table of data. The metadata 408 may include other information associated with the input data such as an identifier of a person associated with the missing column of data 407, an identifier of a software application associated with the missing column of data 407, an identifier of an account associated with the missing column of data 407, an identifier of a geographic location, a date, a time, and/or the like.

According to various examples and features of the instant solution, the AI bot 440 may include an AI model therein that is configured to find a storage location of the missing column of data 407 using the metadata 408 such as the name, account identifier, software identifier, date, geographic location, or the like. Here, the AI bot 440 may scan the source databases 442, 444, and 446 based on the missing column of data 407 and the metadata 408 to find an existing column of data 409 that matches the missing column of data 407. Here, the missing column of data 407 can be retrieved from the source database 446 by the AI bot 440 and submitted to the data retriever 430 of the data validation module 423. In response, the data validation module 423 may modify the tokenized data 404 to include the existing column of data 409 and continue with the rest of the AI pipeline.

In some examples and features of the instant solution, the existing column of data 409 may already be tokenized data. When the existing column of data 409 is not tokenized, the pre-process module 422 may be executed on the existing column of data 409 to tokenize the data prior to integrating the existing column of data 409 into the tokenized data 404.

FIG. 4D illustrates a process 400D of retrieving synthetic input data from a generative AI model in response to detecting the missing column of data 407 within the tokenized data 404. Referring to FIG. 4D, the data retriever module 430 of the data validation module 423 can query a large language model (LLM) 450 with the identifier of the missing column of data 407 and the metadata 408. In response, the LLM 450 may generate synthetic data that satisfies the requirements of the missing column of data 407. Here, the LLM 450 may ingest data samples from a data sample database 460 and generate new data samples for a new column of data 452 that matches a type, a format, etc. of the missing column of data 407.

In this example of the instant solution, the LLM 450 may be trained to generate input data based on historical input data used for artificial intelligence pipelines which is stored in the data sample database 460. In response, the LLM 450 may create synthetic data that may include raw data, tokenized data, or the like, and store it within the new column of data 452. Further, the LLM 450 may return the new column of data 452 to the data retriever module 430 of the data validation module 423. In response, the data validation module 423 may modify the tokenized data 404 to include the new column of data 452 and continue with the rest of the AI pipeline.

In some examples and features of the instant solution, before continuing the pipeline, the pipeline software 420 may display a confirmation window via the GUI 412 of the software. For example, FIG. 4E illustrates a process 400E of receiving confirmation of the existing column of data 409 via the GUI 412, prior to restarting the AI pipeline. The same confirmation process may be performed using the new column of data 452 generated in FIG. 4D.

Referring to FIG. 4E, the data validation module 423 may output an identifier 413 of the existing column of data 409 via the GUI 412 along with control mechanisms 414 and 415 for confirming or canceling the use of the existing column of data 409. Here, the identifier 413 may include the actual data values. As another example, the identifier 413 may include metadata of the existing column of data 409 such as a name of the column, a location, a date, or the like. A user may use an input mechanism such as a cursor, a touch input, or the like, to select one of the control mechanisms. In this example, the user presses on control mechanism 414 which “confirms” the existing column of data is valid. As another example, the user may press on the control mechanism 415 which rejects the existing column of data as valid, and which can cause the data validation module 423 to search for a new column of data.

The decision to use the AI bot 440 shown in FIG. 4C or the LLM 450 shown in FIG. 4D may be determined by the user based on inputs through the GUI 412. As another example of the instant solution, the software may automatically attempt to find an existing column of data for the missing column of data from existing data held in the source databases 442, 444, and 446 using the AI bot 440. When this process fails, the software executes the LLM 450 to generate the synthetic data. Therefore, the synthetic data may be an alternate option. As another example, the synthetic data may be the primary option.

Returning now again to FIG. 4A, with the tokenized data 404 modified to include the additional/new input data, the rest of the AI pipeline can be performed including executing the AI model 424 on the modified tokenized data and generating an output 425 which can be further analyzed or used in a subsequent downstream process such as another AI pipeline, etc.

FIGS. 5A-5C are diagrams illustrating a process of pausing an AI pipeline and resuming the AI pipeline after fixing the input data according to examples and features of the instant solution. For example, FIG. 5A illustrates a process 500A of detecting a location within a pipeline 510 at which the pipeline 510 is paused according to various examples and features of the instant solution. Referring to FIG. 5A, the pipeline 510 may refer to an artificial intelligence pipeline, a machine learning, or the like, which includes one or more AI models, ML models, etc. integrated therein. The pipeline 510 may perform a training process, an inference process, or the like using the one or more AI models, ML models, etc.

In the example of FIG. 5A, the pipeline 510 may be started via a software application 520 such as a pipeline management software application. The pipeline 510 may include a plurality of steps 511, 512, 513, 514, 515, 516, and 517 which perform a plurality of tasks on input data such as training data, raw data, etc. In this example, the software application 520 may pause the pipeline 510 at a location 518 within the pipeline 510 based on detection of invalid input data. In this example, input data 502 may be input to a first step 511 of the pipeline 510. At the same time (simultaneously), the input data 502 may be analyzed by the software application 520 for validity. As an example, a data validation module (such as described in FIGS. 4A-4E) may be used to determine whether the input data 502 is valid.

In the example of FIG. 5A, the pipeline 510 executes the step 511, the step 512, and starts executing the step 513. While executing the step 513, the software application 520 determines that the input data 502 is invalid. Here, the software application 520 may pause the pipeline 510 at a location 518 within the pipeline 510. The location 518 may refer to a task, method, etc. which is about to be performed by step 513. As another example, the location 518 may be a start of the step that is currently being performed. The software application 520 may generate metadata 522 that identifies the location 518 within the pipeline 510 at which the pipeline is paused.

By pausing the pipeline 510, the software application 520 prevents additional steps from being performed on the invalid input data, thereby conserving resources of the system. In addition, by pausing the pipeline 510, the software application preserves the work that has already been performed on the input data 502. As such, the work that has already been performed is not repeated for any of the input data that is valid.

FIG. 5B illustrates a process 500B of queuing the metadata pertaining to the paused pipeline within a temporary storage 530 (e.g., a queue, etc.) according to examples and features of the instant solution. Referring to FIG. 5B, the software application 520 may maintain a temporary storage 530 for preserving information about pipelines which have been paused due to invalid input data. In this example, the temporary storage 530 includes a first entry 540 that corresponds to a pipeline that is paused and waiting for valid input data and a second entry 542 that corresponds to another pipeline that is paused and waiting for valid input data. Here, the software application 520 may generate a queue entry 532 for the pipeline 510, which is paused in the process of FIG. 5A, and store the queue entry 532 within the temporary storage 530.

The queue entry 532 may include an identifier of the pipeline 534, a flag 536 identifying the location 518 at which the pipeline 510 is paused, the current state of the input data at the location 518 within the pipeline, and the like. In some examples and features of the instant solution, the queue entry 532 may include additional attributes such as an identifier of the AI model(s) within the pipeline 510, an identifier the input data, a timestamp at which the pipeline 510 is paused, an amount of progress that has been performed, an identifier of the step/task at which the pipeline is paused, and the like.

In some examples and features of the instant solution, the software application 520 may manage the temporary storage 530 by removing old entries that have been pending for more than a predetermined amount of time such as 1 hour, 1 day, etc. Here, the software application 520 may refer to the timestamps of the entries (when they were created) and compare the timestamps to a current time, such as a system clock of the host platform. When the difference between the current time and the timestamp is greater than a predefined threshold of time, the queued entry may be deleted from the temporary storage 530 by the software application 520.

FIG. 5C illustrates a process 500C of resuming execution of the pipeline 510 in response to the input data being corrected according to examples and features of the instant solution. Referring to FIG. 5C, the software application 520 may retrieve additional input data (e.g., missing data 552) from a data source 550 to cure the input data 502 of the pipeline 510 which is determined to be invalid. Here, the missing data 552 may be combined in some way with the input data 502 to generate modified input data. The software application 520 may resume the pipeline 510 at the location 518 in the pipeline at which the pipeline 510 was paused based on the queue entry 532 stored within the temporary storage 530 shown in FIG. 5B. In addition, the software application 520 may delete the queue entry 532 from the temporary storage 530 in response to restarting the pipeline 510.

By restarting the pipeline 510 from the location 518 at which the pipeline 510 was previously paused, the resources consumed by the pipeline to get to the location 518 can be conserved. For example, the input data that remains may be cleaned, tokenized, vectorized, etc. prior to the pausing of the pipeline 510. The work done to perform these tasks on the valid input data can be conserved. When the missing data 552 requires any additional steps, the software application 520 may cause the pipeline 510 to execute the previous steps of the pipeline on the missing data 552 since the valid input data has already had these steps performed and the work has been saved.

FIGS. 6A-6B illustrate a process of validating a tokenizer of an AI operational pipeline according to examples and features of the instant solution. For example, FIG. 6A illustrates a process 600A of validating a tokenizer 620 based on input data 610 input to the tokenizer 620 and output data (e.g., tokenized data 611) generated by and output from the tokenizer 620. Referring to FIG. 6A, the input data 610 may be ingested by a tokenizer 620, for example, during runtime of a pipeline such as an AI pipeline, an ML pipeline, an AI development system 240 (see, for example, FIGS. 2A-2C), or the like. The input data may include tabular data in this example. The tokenizer 620 may convert the tabular data into tokens (tokenized data values) that are stored within the tokenized data 611.

According to various examples and features of the instant solution, a tokenizer validation module 660 may validate the tokenizer 620 without having access to the underlying source code of the tokenizer 620. Instead, the tokenizer validation module 660 may validate the tokenizer 620 based on the input data 610 input to the tokenizer 620 and the tokenized data 611 that is output by the tokenizer 620. That is, even when the tokenizer validation module 660 does not have access to the internal steps performed by the tokenizer 620, the tokenizer validation module 660 can still verify that the tokenizer 620 is working properly based on a comparison of the input data and the output data. As another example, rather than using the input data 610, the tokenizer validation module 660 may use a token data model such as a model that is created during training of the AI model, or the like.

FIG. 6B illustrates a process 600B of determining whether the tokenizer 620 is valid based on a comparison of the input data 610 to the tokenized data 611 according to the examples and features of the instant solution. Referring to FIG. 6B, the tokenizer validation module 660 may compare the format, columns, data values, data variables, column count, etc. within the input data 610 to the tokens stored within the tokenized data 611. Here, the tokenizer 620 may remove the columns from the input data when converting the input data into the tokenized data 611. However, the tokenizer 620 may create rows of tokens that correspond to the columns. For example, when the input data 610 includes a table with seven columns, the output data is expected to include rows of tokens with seven tokens in each row. When the rows do not include the same number of tokens as columns in the input data 610, the tokenizer validation module 660 may determine that the tokenizer 620 is invalid.

When determined to be invalid, the tokenizer validation module 660 may trigger the software to replace the tokenizer 620 with a different tokenizer. As another option, the tokenizer validation module 660 may modify the input data 610 in an effort to achieve accurate results of the tokenizer 620. For example, the tokenizer validation module 660 may add a space, a comma, a data value, or the like, to the input data 610 to help the performance of the tokenizer 620. As another example, the tokenizer validation module 660 may add a new column of data to the input data 610 that is missing. As another example, the tokenizer validation module 660 may replace a column of data with a different column of data. The new data may be retrieved using any of the examples described herein with respect to FIGS. 4A-4E.

Here, the tokenizer validation module 660 may trigger the tokenizer 620 to run again on the modified input data to generate modified tokenized data. In this case, the tokenizer validation module 660 may validate the tokenizer 620 by comparing the modified input data to the modified tokenized data. When not valid, the same process may be repeated a predetermined number of steps, times, etc. When the tokenizer 620 is still not working properly, the tokenizer 620 may be replaced with a different tokenizer.

In the example of FIG. 6B the tokenizer validation module 660 performs a comparison between the input data 610 and the tokenized data 611. As another example, the tokenizer validation module may perform a comparison between a token data model of an AI model within the pipeline to the tokenized data 611. As another example, the system may create a token data model from the input data 610.

FIGS. 6C-6D illustrate a process of validating embeddings of a transformer of the AI operational pipeline according to examples and features of the instant solution. For example, FIG. 6C illustrates a process 600C of generating embeddings in an embedding space 650 based on the input data 610. The process shown in FIG. 6C may be performed after the tokenizer validation process described with respect to the examples in FIGS. 6A and 6B, or it may be performed without the tokenizer validation process.

Referring to FIG. 6C, the tokenized data 611 generated by and output from the tokenizer 620 may be input to a vectorizer 630 which converts the tokenized data 611 into vectors 612 (e.g., maps/assigns the tokens to unique IDs or numbers in vector space). Duplicate tokens may receive the same vector ID. The vector IDs may correspond to points in vector space.

To give the tokens meaning, a deep learning model, such as a transformer model 640, may be trained on the vectors 612. This allows the model to understand the meaning of words and how they relate to each other. The goal of this process is to enable natural language processing (NLP) models to understand the meaning and semantics of different words and their context within a sentence or text. The vectors are numerical representations of the meaning of a token and how it relates to other tokens in the vocabulary. Here, the transformer model 640 can create embeddings in an embedding space 650 corresponding to the vectors 612 output by the vectorizer 630. The embeddings are points in multi-dimensional space that correspond to the vectors and that are positioned based on meaning. Similar words/related words will be located in similar locations within the embedding space 650.

In some examples and features of the instant solution, the software described herein may identify a cluster 652 of points (embeddings) within the embedding space 650 that correspond to the input data 610. Here, the input data 610 may correspond to a particular type of data (e.g., mortgage data, savings account data, credit card data, automobile loan data, etc.). As another example, the input data 610 may be provided from a specific source, or the like. The cluster 652 may be used as a model of the input data 610 of that particular type and/or of that particular source of the data. Thus, the location of the cluster 652 may be used to as an embedding model of the input data 610 to validate subsequent data received that is of the same type and/or from the same source as the input data 610.

FIG. 6D illustrates a process 600D of validating input data 615 of a same type based on the embedding model of the input data 610 generated in FIG. 6C. Referring to FIG. 6D, input data 615 may be new data that is input to the tokenizer 620 as part of a process performed via an AI pipeline. In this example, the input data 615 may correspond to an inference to be performed by an AI model (not shown) that is downstream from the tokenizer 620 in the pipeline. Here, the tokenizer 620 may convert the input data 615 into tokenized data 616 according to the examples described herein. Furthermore, the vectorizer 630 may convert the tokenized data 616 into vectors 617. Furthermore, the transformer model 640 may embed the vectors 617 in the embedding space 650. In this example, the embeddings of the vectors 617 may result in points that are plotted within the embedding space 650.

Here, the software may determine that the input data 615 corresponds to the input data 610 (FIG. 6C) in some way, for example, based on the types of the input data 610 and the input data 615 being the same, based on the sources of the input data 610 and the input data 615 being the same, or the like. To validate the input data 615, an embedding validation module 670 may compare the embeddings of the input data 615 within the embedding space 650 to the embedding model of the input data 610. In this case, the embedding model corresponds to the cluster 652. Here, a new cluster 654 in a different space is created by the embeddings of the input data 615.

The embedding validation module 670 may measure a distance “d” 656 between the cluster 652 corresponding to the embeddings of the input data 610 in the embedding space 650 and the new cluster 654 corresponding to the embeddings of the input data 615 in the embedding space 650. For example, cosine similarity or the like may be performed. When the distance “d” 656 is above a threshold distance, the embedding validation module 670 may determine the input data 615 is invalid and may fix the input data 615, obtain missing input data, pause the pipeline, terminate the pipeline, or the like.

The instant solution comprises a memory configured to store an artificial intelligence model and a processor configured to perform various functions critical to the operation and validation of an AI pipeline. The processor trains an AI model using neural network capabilities based on training data to generate a trained AI model. The training process feeds the neural network with a substantial dataset, allowing the network to learn and adjust its weights to increase the accuracy of its predictions. Once the AI model is trained, the processor integrates the trained model into an AI pipeline via a software application. The integration embeds the AI model within the operational framework of the AI pipeline, ensuring that it can receive input data and execute its functions seamlessly within the larger system.

The solution receives input data via the software application and initiates the execution of the AI pipeline on the input data. The processor monitors the input data during runtime to ensure its validity. This involves comparing the content of the input data with the training content included in the training data. The comparison checks for discrepancies such as missing columns, unexpected data types, or out-of-range values that might indicate that the input data is not what the model expects. When the processor determines that the input data is invalid based on the comparison, it stops the execution of the AI pipeline on the invalid input data, preventing the pipeline from wasting computational resources on data that may likely yield unreliable predictions. Furthermore, to inform the user of the issue, the processor presents a notification via a GUI of the software application. The notification explicitly indicates that the input data is invalid, providing the user with the feedback necessary to correct the input data before resuming the pipeline. The solution also includes functionality to handle specific cases of invalid data. For instance, when the processor identifies that the input data is missing one or more columns of content or contains extra columns that are not present in the training data, it triggers additional data validation processes. These processes may involve accessing databases or using AI bots to retrieve missing data and employing large language models (LLMs) to generate synthetic data that fits the expected format.

The instant solution ensures the validity and reliability of an AI pipeline by implementing various validation and corrective measures. Upon receiving the training data via the software application, the instant solution determines the validity of the received training data. The determination process compares the received training data to previously received training data to identify any discrepancies or issues. For instance, the instant solution checks for missing columns of content or missing column headers, which are critical for maintaining the structure and integrity of the training data. When such issues are detected, the training data is flagged as invalid. Furthermore, the instant solution includes tokenizing the training data, which involves converting the raw training data into a format suitable for processing by the AI model. The tokenized data is then subjected to another validation check to ensure consistency with previously tokenized training data. The validation step ensures that the format and structure of the tokenized data align with the expected input for the AI model. The instant solution presents an alert via the software application's GUI to notify users of the invalid data. The instant solution also logs the alert for record-keeping and auditing purposes. To prevent the AI pipeline from processing invalid data, the instant solution stops the pipeline's execution until the data issues are resolved. The instant solution also provides options for restarting the AI pipeline once the data has been corrected, skipping the invalid training data to continue processing valid data, fixing errors in the training data to make it valid, or modifying the training data to conform to the required standards.

The instant solution is configured to determine when input data is missing at least one column of content by comparing the content of the input data with the training content included in the training data. During the runtime of the AI pipeline, the processor monitors the input data as it is received via the software application. The input data is compared against the structure and content of the training data used to train the AI model. The training data serves as a reference model, containing the expected columns and data types that the AI model has been trained to process. When the processor detects that the input data is missing one or more columns of content based on the comparison, it interrupts the pipeline's execution. The detection mechanism checks the presence of all expected columns as defined in the training data schema. When any column that is part of the training data schema is absent in the input data, the processor identifies this discrepancy.

Once the absence of a column is identified, the processor stops the execution of the AI pipeline to prevent further processing of incomplete data, which may lead to unreliable or incorrect outputs. Along with stopping the pipeline, the processor generates a notification via the software application's GUI. The notification informs the user of the specific issue, indicating which content columns are missing from the input data. Additionally, the processor invokes a data validation module to address the missing data issue. The module may include an AI bot that scans existing databases to find and retrieve the missing column of data. When the required data is available in the databases, it is retrieved and integrated into the input data, ensuring completeness. When the missing data cannot be found, the processor may employ an LLM to generate synthetic data that satisfies the requirements of the missing column, thus enabling the pipeline to continue operating with valid input data.

The instant solution validates the training data within an AI pipeline to ensure data integrity and reliability by determining the invalidity of received training data and identifying missing content compared to previously received training data. The instant solution receives training data via a software application designed to manage and execute an AI pipeline. The training data is subjected to a validation process where the software application checks for completeness and accuracy. The software application compares the received training data against a reference set of previously received training data. The comparison detects any missing columns of content, which are essential for maintaining the data's structural integrity. For example, when a specific column that was present in the reference training data is absent in the newly received data, the instant solution identifies this discrepancy and flags the data as invalid. This ensures that all required data attributes are present for accurate AI model training.

The solution also includes verifying the presence of column headers in the received training data. Column headers are crucial for identifying and interpreting the data correctly. The software application compares the headers of the received training data with those of the reference set. When one or more column headers are missing, the instant solution determines that the training data is invalid. This prevents the AI model from being trained on incomplete or misinterpreted data, which may compromise the model's performance. Upon identifying missing columns of content or headers, the instant solution implements corrective actions to address the data invalidity. The actions may include presenting an alert via a GUI to notify users of specific issues, logging the alert for record-keeping, and stopping the AI pipeline to prevent further processing of invalid data. The instant solution also provides options to fix the identified errors by prompting the user to supply the missing data or automatically retrieving the missing columns from a pre-defined data source.

The instant solution validates training data within an AI pipeline, mainly focusing on detecting invalid data formats during the tokenization process. The instant solution receives raw training data via a software application and performs a tokenization process, transforming the data into a structured format suitable for processing by the AI model. Tokenization converts text or other data into tokens, the fundamental units of information the AI model can analyze and learn from. Once the training data is tokenized, the instant solution proceeds to validate the format of the tokenized data. The software application compares the tokenized training data to a reference set of previously tokenized data to ensure consistency. The comparison involves checking various aspects of the tokenized data, such as the structure, format, and arrangement of tokens. When discrepancies are found, the instant solution flags the data as invalid.

The solution identifies invalid tokenized data by detecting differences in format, such as variations in token patterns, unexpected token sequences, or structural inconsistencies. The format differences can arise from various issues, such as errors during the tokenization process or inconsistencies in the raw training data. By identifying the discrepancies, the instant solution ensures that the AI model is trained on data that meets the required format standards, thus maintaining the integrity and accuracy of the training process. The instant solution implements several corrective actions upon determining that the tokenized training data is invalid. The actions may include presenting an alert via a GUI to notify users of the detected format issues, logging the alert for documentation purposes, and stopping the AI pipeline to prevent further processing of invalid data. Additionally, the instant solution provides options to correct the identified format errors, such as prompting the user to review and adjust the tokenization settings or automatically re-tokenizing the data using the correct parameters.

The instant solution is configured to determine that the input data is sourced from a storage location different from the training data. The determination ensures that the AI pipeline operates with data from known and trusted sources, thereby maintaining the integrity and reliability of the AI model's outputs. The processor receives the input data via the software application, which is integrated into the AI pipeline. The processor initiates a verification process to determine the source of the input data. The verification involves checking the metadata associated with the input data, which includes information about its storage location. The training data, previously used to train the AI model, includes metadata identifying its storage location. The storage location may be a specific database, server, cloud storage, or other data repository. The processor accesses the metadata to retrieve the storage location details of the training data.

Upon receiving the input data, the processor compares its storage location metadata with that of the training data. The comparison involves checking the database names, server addresses, file paths, and any other relevant identifiers that specify the source of the data. When the processor identifies that the input data is sourced from a different storage location than the training data, it recognizes a potential issue. The difference in storage locations might indicate that the input data is inconsistent with the data the AI model was trained on, possibly leading to discrepancies in data format, structure, or quality. To prevent the AI model from processing potentially incompatible data, the processor stops the execution of the AI pipeline. The processor generates a notification via the GUI of the software application. The notification informs the user about the discrepancy, specifying that the input data originates from a storage location different from the training data. The notification may include details about the identified storage locations, allowing the user to verify and rectify the source of the input data. The processor may engage a data validation module to perform several actions, such as retrieving input data from the correct storage location, validating the current input data's compatibility with the training data, or requesting new input data from a trusted source. These corrective actions ensure that the AI pipeline operates with data consistent with the training data, maintaining the accuracy and reliability of the AI model's outputs.

The instant solution is configured to modify the input data that is not valid to generate valid input data, restart the execution of the AI pipeline on the valid input data, and present an additional notification via the GUI of the software application indicating the AI pipeline has been restarted. This capability ensures that the AI pipeline can recover from data validity issues and continue processing without manual intervention, thus enhancing its robustness and reliability. When the processor determines that the input data is invalid based on the comparisons, it stops the execution of the AI pipeline. This prevention step ensures that the AI model does not process flawed data, which may lead to inaccurate or unreliable predictions.

Upon stopping the pipeline, the processor engages a data validation module to address the invalid data issue. The module includes mechanisms for modifying the input data to generate valid input data. When the input data is missing certain columns or values, the processor retrieves the necessary data from relevant data sources or databases using an AI bot or a similar retrieval mechanism. When the missing data cannot be retrieved, the processor employs an LLM to generate synthetic data that satisfies the requirements of the missing columns or values. The LLM creates data samples that match the type, format, and context of the missing data. When the input data has incorrect formats, the processor transforms the data to align with the expected format, including actions like converting data types, normalizing values, or adding necessary delimiters. When the input data contains invalid values, the processor replaces the values with valid ones sourced from historical data, other relevant databases, or generated by the LLM.

Once the input data has been modified to meet the validity requirements, the processor restarts the execution of the AI pipeline from where it was previously stopped, ensuring that the work already performed on the valid portions of the data is preserved, preventing unnecessary repetition and conserving computational resources. After restarting the pipeline, the processor generates an additional notification via the software application's GUI. The notification informs the user that the AI pipeline has been restarted and is now processing the modified valid input data. The notification may include details about the modifications made to the input data, providing transparency and enabling the user to verify the changes when necessary.

The instant solution is configured to determine when the content included in the input data is not valid based on the execution of a library accessible to the software application. The functionality ensures that the AI pipeline can leverage external validation libraries to enhance the robustness and accuracy of its data validation processes. Upon receiving the input data via the software application, the processor initiates a validation process that involves invoking an external library. The library contains a collection of predefined validation rules, algorithms, and functions specifically designed to assess the validity of data based on various criteria. The external library may include modules for checking data formats, detecting missing or extra columns, verifying data types, identifying outliers, and ensuring data consistency with the training data used for the AI model. These validation rules may be more comprehensive and specialized than those built directly into the AI pipeline, allowing for more thorough data validation.

The processor passes the input data to the external library to begin the validation. The library executes its validation routines on the input data, applying predefined rules and algorithms to assess its validity. The execution involves multiple steps. Schema validation checks when the input data adheres to the expected schema, including all required columns and the absence of unexpected columns. Data type verification ensures that the data types of the input values match those expected based on the training data. Range and consistency checks verify that the data values fall within acceptable ranges and are consistent with historical data patterns. Format checks confirm that the data is in the correct format, such as date formats, numerical precision, and text encoding.

When the external library determines the input data is invalid, it returns detailed information about the validation failures to the processor. The processor stops the execution of the AI pipeline to prevent the processing of invalid data. The processor generates a notification via the software application's GUI, informing the user of the validation issues identified by the external library. The notification may include detailed error messages and suggestions for correcting the invalid data, enabling the user to take appropriate corrective actions. The processor may also engage a data validation module to attempt automatic corrections based on the feedback from the external library.

In another example of the instant solution, an AI model is trained using a neural network capability based on training data to generate a trained AI model. This process involves leveraging the AI Development System 240 (see, for example, FIGS. 2A-2C), which extracts and prepares data, identifies features, and splits the data into training and validation sets. The training module then utilizes the neural network to learn patterns from the training data, producing a trained AI model. The training of the AI model may be performed in an ongoing timeframe. Once the AI model is trained, it is received into the AI operational pipeline via a software application hosted on a cloud platform or web server. This integration allows the model to be used in various predictive tasks within the AI pipeline. The AI Development System 240 stores the trained model in an AI model registry 260 (see, for example, FIGS. 2A-2C), which can be retrieved by the AI Production System 230 (see, for example, FIGS. 2A-2C) for deployment. The training data is received via the software application, where it is ingested and pre-processed, and this may include cleaning, normalizing, and tokenizing the data. This process identifies missing values, outliers, or other data issues and corrects them to ensure the data is in the correct format for training and inference. The instant solution determines when the received training data is invalid. This is done by comparing the received training data to the expected format and structure defined during the model training phase. When the data does not conform to these expectations, it is flagged as invalid. The training data is then tokenized, and the tokenized data is validated by comparing it to a token data model created during the training phase. This process checks for consistency in the number of tokens, column counts, and data values. When discrepancies are found, the tokenized data is deemed invalid. In response to determining the invalidity of either the received training data or the tokenized training data, the software application performs several actions, such as presenting an alert via a GUI to notify the user of the issue. Additionally, the application logs the alert for record-keeping and analysis. The AI pipeline can be stopped to prevent further processing of invalid data. Alternatively, the pipeline may be restarted after the data issue has been corrected. The application may skip the invalid training data, fix errors within the data, or modify the training data to ensure it meets the required standards.

In another example of the instant solution, the solution analyzes the data for completeness and structural integrity after receiving the training data via the software application. This involves comparing the received training data to previously received data to identify discrepancies. The received training data is invalid when it is missing at least one content column compared to the previously received training data. This comparison involves checking the required columns that exist based on the historical data patterns and the defined schema used during the model training phase. Additionally, the received training data is identified as invalid when it is missing at least one column header compared to the previously received training data. Column headers are essential for correctly interpreting the data, as they define the nature and type of data contained within each column. The pre-processing module ensures all expected column headers are present; any omission triggers an invalidity flag. The structure of the previously received training data is used as a benchmark. When any missing columns of content or headers are detected, the software application will then take appropriate actions as previously described, such as presenting an alert via the GUI, logging the alert, stopping or restarting the AI pipeline, skipping the invalid data, fixing errors, or modifying the training data.

In another example of the instant solution, the invalidity of the received training data is determined by identifying that the tokenized training data is of a different format when compared to previously tokenized received training data. After receiving the training data via the software application, it undergoes tokenization. The tokenized data is then validated by comparing the format of the tokenized training data to the format of previously tokenized training data, which is stored in the system as a reference model. The comparison involves checking various aspects of the data format, such as token structure, tokenized column arrangement, and overall consistency with the previously established format. The data is flagged as invalid when the tokenized training data deviates from the expected format, such as differing token lengths, incorrect column arrangements, unexpected token patterns, and the like. In response, the solution can take several actions: it may present an alert via the GUI to notify the user of the invalid data format, log the incident for further review, stop the AI pipeline to prevent the use of invalid data, restart the pipeline after addressing the issue, skip the problematic training data, attempt to fix errors in the data or modify the data to match the expected format.

In another example of the instant solution, the invalidity of the received training data is determined when at least one column content is in a different format from previously received training data. After the training data is received via the software application, it is ingested and pre-processed, and each column of the training data is examined to ensure that the content within these columns adheres to the expected format established by previously received training data. This may involve checking for consistent data types (e.g., numerical, categorical, text, etc.), data value ranges, predefined data formatting rules, and the like. The format of each column in the new training data is compared to the format of corresponding columns in the previously received training data. When the content in any column is inconsistent, such as a column expected to contain numerical data instead containing text or values falling outside the expected range, the data is flagged as invalid. The solution performs one or more of the previously described actions upon detecting invalid column content.

In another example of the instant solution, the invalidity of the received training data is determined by identifying that it comprises a different set of variables compared to previously received training data. After the training data is received via the software application, it is ingested and pre-processed, by the pre-processing module. The variables (features) present in the new training data are evaluated to ensure they match the set of variables used in the previously received training data. This may involve checking for the presence and consistency of specific expected variables based on the historical training data. The variables in the new training data are compared against those from the previously received training data stored in the system. When the new training data contains different variables (either missing some expected variables or including additional, unexpected variables), it is flagged as invalid. This ensures that the model training process is based on a consistent set of features, which is essential for maintaining the accuracy and reliability of the AI model.

In another example of the instant solution, the invalidity of the received training data is determined by identifying that it is sourced from a different training set than the previously received training data. After the training data is received via the software application, it is ingested and pre-processed. The instant solution determines the source of the training data to ensure consistency with the sources used in previous training data. This may involve checking metadata associated with the training data, such as the origin, database, dataset identifiers, and the like. The source information of the new training data is compared against the source information of previously received training data stored in the system. When the new training data is identified as coming from a different training set than expected, it is flagged as invalid.

In another example of the instant solution, data integrity within an AI model's predictive pipeline is managed, ensuring the validity of both raw and tokenized data before processing it for predictions. Data for an AI model is stored within the software application's storage. This includes storing the raw data used by the AI model, a model of this data, and a model of the tokenized data. These models serve as benchmarks for validating incoming runtime data. When the stored model of the data for the AI model is retrieved into the software application, it facilitates the validation of new data. The instant solution retrieves runtime data intended for the AI model and ingests this data into the model. This runtime data is then tokenized and converted into a format suitable for processing by the AI model. Upon receiving a request to execute a predictive pipeline that includes the AI model on the runtime data, the instant solution determines its validity. This determination is made by comparing the runtime data to the stored model of the data for the AI model. When the runtime data matches the expected format and content, the process continues; otherwise, it is flagged as invalid. The instant solution also checks the validity of the tokenized runtime data by comparing it to the stored model of the tokenized data for the AI model. This ensures that the tokenization process has been correctly applied and that the tokenized data aligns with the expected structure and content. When either the runtime data or the tokenized data is invalid, the solution performs one or more corrective actions. These actions may include dismissing the invalid runtime data, loading additional data to supplement or replace the invalid data, presenting an alert within the software application to notify users, logging the alert for record-keeping, stopping the predictive pipeline to prevent the use of invalid data, or proceeding with the predictive pipeline when the issues can be resolved. When no invalid data is detected in either the raw or tokenized forms, the instant solution proceeds to execute the predictive pipeline. This involves using the validated runtime data to generate a predictive output, ensuring that the AI model's predictions are based on accurate and reliable data.

In another example of the instant solution, the integrity and reliability of training data used for an AI model is ensured by validating raw and tokenized data before proceeding with the training process. Training data is stored for an AI model in the storage of a software application. This training data is the foundation for building and refining the AI model. The instant solution then retrieves the stored training data and ingests it into the AI model, initiating the training process. The training data undergoes tokenization, which converts the raw data into a format suitable for the AI model to process. After tokenization, the instant solution creates a model of the training data, capturing the structure and key characteristics of the data. This model is then stored in the software application's storage for future reference. A model of the tokenized training data is created and stored to capture the structure and characteristics of the tokenized data, providing a benchmark for validating future data. The validity of the training data is determined by comparing it to the stored model of the training data. When discrepancies are found, indicating that the training data is invalid, the instant solution flags it. Similarly, the tokenized training data is validated by comparing it to the stored model of the tokenized data. Any discrepancies here also result in the data being flagged as invalid. Upon detecting invalid training data or invalid tokenized data, the solution responds with various actions. These actions may include dismissing the invalid runtime data, updating the stored models of the training data or tokenized data to reflect any corrections, loading additional runtime data to supplement or replace the invalid data, presenting an alert within the software application to notify users, logging the alert for record-keeping and analysis, stopping the training pipeline to prevent the use of invalid data, or executing the model training pipeline when the issues can be resolved. When no invalid data is detected in either the raw or tokenized forms, the instant solution proceeds to execute the training pipeline. This involves using the validated training data to train the AI model, ensuring that the model is built on accurate and reliable data.

In another example of the instant solution, the solution ensures the validity of runtime data used in an AI pipeline for executing predictive tasks. This process enhances the reliability of the AI model's predictions by validating and correcting the runtime data before continuing the predictive process. A predictive process is executed on runtime data via an AI pipeline. This pipeline includes at least an AI model, the runtime data, and a model trained on the runtime data. The AI model uses this data to generate predictions for the pipeline's execution. During this process, the solution determines when the runtime data is invalid by comparing it to the stored data model. This model serves as a benchmark, defining valid runtime data's expected structure and characteristics. The runtime data is flagged as invalid when discrepancies are found during this comparison. Upon detecting invalid runtime data, the solution retrieves valid runtime data from the storage of the software application. The invalid runtime data is then modified based on this valid data to generate modified runtime data. This modification ensures that the corrected data aligns with the expected format and content required for accurate predictions. To facilitate the correction process, the solution stores an identifier of the location within the AI pipeline where the execution of the predictive process was stopped or paused. This identifier allows the solution to pinpoint the exact stage in the pipeline where the invalid data was detected and halted. Once the invalid data is replaced with valid data, the solution resumes executing the predictive process on the modified runtime data. The resumption occurs at the exact location within the AI pipeline where the process was previously stopped, based on the stored identifier. This ensures a seamless continuation of the predictive process without restarting from the beginning, thereby saving time and computational resources.

In another example of the instant solution, an AI pipeline is executed via a software application. The pipeline includes either a training pipeline, an inference pipeline, or both. Various data elements are received through the software application, which may include training data, runtime data, tokenized training data, or tokenized runtime data. These data elements are essential for the AI model's operation within the pipeline. The software application defines specific data patterns for these elements, establishing a structured format or template for how the data is expected to appear. The software application creates models of the data elements, each incorporating the defined data patterns. These models are subsequently stored within the software application's storage system. When new data elements are received, the software application determines their validity by comparing them to the pre-established models of the data elements. When the new data elements match the expected patterns, they are deemed valid, and the AI pipeline continues its execution without interruption. This seamless operation ensures that the AI model receives accurate and reliable data for processing. However, when the new data elements are found to be invalid, the pipeline responds by performing one or more actions. These actions may include dismissing the invalid data elements, loading additional data elements to replace or supplement the invalid ones, presenting an alert within the software application to notify users of the issue, logging the alert for record-keeping and further analysis, stopping the pipeline to prevent the use of flawed data, or continuing with the predictive pipeline and generating a predictive output despite the data inconsistency.

In another example of the instant solution, a correction system designed for financial transactions performs real-time data validation. The instant solution ensures that the input data used for financial predictions and decisions is accurate and valid before being processed by AI models. The instant solution includes a memory and a processor. The processor is configured to train an AI model using historical financial data, such as transaction records, stock prices, market trends, and the like. The training process utilizes a neural network to generate a trained AI model to predict market movements, detect fraud, optimize trading strategies, or the like. The processor also integrates the trained AI model into an AI pipeline within a financial or trading software application. The pipeline handles real-time financial data, ensuring seamless data flow and processing. The processor receives input data from various sources, such as transaction databases, market feeds, and user inputs. valid the data against the training data schema, checking for missing or additional columns, incorrect formats, and inconsistent values. When invalid data is detected, the instant solution stops the AI pipeline and immediately notifies the user via a GUI. The notification includes details about the invalid data, such as missing fields or unexpected values, allowing the user to correct the data. The instant solution automatically retrieves missing data from historical transaction records and generates synthetic data using an LLM. It then modifies the input data to make it valid and restarts the AI pipeline.

In another example of the instant solution, a healthcare data validation and inference system is designed to handle medical records and patient data, ensuring that the data used for medical predictions and diagnostics is accurate and complete. The instant solution includes a memory and a processor. The processor is configured to train an AI model using historical healthcare data, including patient records, lab results, treatment outcomes, and the like. The training process uses a neural network to create a model to predict patient diagnoses, recommend treatments, identify potential health risks, or the like. The instant solution integrates the trained AI model into an AI pipeline within a healthcare management software application. The pipeline processes patient data in real time, ensuring seamless data handling and analysis. The processor receives input data from various sources, such as electronic health records (EHR), lab databases, and patient inputs, and validates the data against the training data schema, checking for missing or additional columns, incorrect formats, and inconsistent values. When invalid data is detected, the instant solution stops the AI pipeline and notifies healthcare professionals via a GUI. The notification includes details about the invalid data, such as missing lab results or incorrect patient information, allowing for prompt correction. The instant solution retrieves missing data from patient records and generates synthetic data using an LLM. It then modifies the input data to make it valid and restarts the AI pipeline from where it was stopped.

In another example of the instant solution, an automated data validation and correction system designed for e-commerce platforms ensures that product and transaction data used for sales predictions, inventory management, and customer recommendations is accurate and valid. The instant solution includes a memory and a processor. The processor is configured to train an AI model using historical e-commerce data, such as sales records, product information, customer behavior, and the like. The training process uses a neural network to create a model to predict sales trends, manage inventory, generate personalized recommendations, or the like. The instant solution integrates the trained AI model into an AI pipeline within an e-commerce software application. The pipeline processes real-time data from the e-commerce platform, ensuring seamless data handling and analysis. The instant solution receives input data from various sources, such as product databases, transaction records, customer inputs, and the like. It validates the data against the training data schema, checking for missing or additional columns, incorrect formats, inconsistent values, and the like. When invalid data is detected, the instant solution stops the AI pipeline and notifies the platform administrators via a GUI. The notification includes details about invalid data, such as missing product information or incorrect transaction details, allowing prompt correction. The instant solution automatically retrieves missing data from product catalogs and generates synthetic data using an LLM. It then modifies the input data to make it valid and restarts the AI pipeline.

The instant solution enhances the reliability of an AI operational pipeline by ensuring the validity of input data before execution. Upon receiving a request to execute the AI pipeline, which includes the AI model, on new input data, the processor first determines whether the input data is valid. The validation process involves comparing the input data against the stored training data model. The processor checks for missing values, incorrect data types, or structural mismatches that may affect the AI model's performance. When the input data is invalid, the processor retrieves additional input data from the software application's storage to fill in any gaps or correct errors.

The processor identifies the type of data missing from the initial input data based on the training data model to retrieve the additional input data. It then searches the storage for datasets containing the required data type, using metadata such as column names, data types, and sources to locate the appropriate datasets. Once the additional data is found, the processor evaluates its validity by comparing it to the training data model, ensuring it meets the required standards and formats. After validating the additional input data, the processor combines it with the initial input data to form a complete and correct dataset. The aggregated input data is used to execute the AI pipeline, including running the AI model to generate a predictive output. By ensuring that the input data is valid and complete before executing the AI pipeline, the instant solution significantly enhances the reliability and accuracy of the AI model's predictions, which helps prevent erroneous outputs and optimizes the use of computational resources by avoiding the execution of the pipeline on flawed data.

The instant solution enhances the reliability of an AI operational pipelines by incorporating mechanisms for validating input data at various stages of the pipeline process. The instant solution stores data for an AI model in a storage component of a software application. The data includes raw data, pre-processed data, and tokenized data that the AI model will use during its training and inference phases. Additionally, the instant solution stores a model of the data for the AI model in the same or another storage component within the software application. The data model includes structured representations of the input data, capturing the format, expected values, and relationships between data elements. A model of the tokenized data of the AI model is stored, which includes representations of the data after it has been processed into tokens suitable for machine learning algorithms.

Upon retrieving the stored model of the data for the AI model into the software application, the instant solution retrieves runtime data for the AI model. The runtime data is ingested into the AI model, which undergoes tokenization. Tokenization converts the runtime data into smaller units (tokens) that the AI model can process, ensuring that the data is in a suitable format for subsequent processing by the AI model. The instant solution proceeds by receiving a request to execute a predictive pipeline that includes the AI model on the runtime data via the software application. The request initiates the pipeline's operation, wherein the ingested and tokenized runtime data is processed by the AI model to generate predictive outputs. Before executing the pipeline, the method includes crucial validation steps to ensure the reliability of the input data. During the validation phase, the instant solution determines when the runtime data is invalid by comparing it to the stored model of the data for the AI model. The comparison involves checking the format, values, and structural integrity of the runtime data against the expected data model. When discrepancies are detected, indicating that the runtime data is invalid, the method proceeds to validate the tokenized runtime data by comparing it to the stored model of the tokenized data for the AI model.

In response to detecting invalid runtime data or invalid tokenized data, the instant solution provides several remedial actions, including dismissing the invalid runtime data, loading additional runtime data to replace or supplement the invalid data, presenting an alert in the software application to notify users of the issue, logging the alert for future reference, stopping the execution of the prediction pipeline to prevent unreliable outputs, or executing the predictive pipeline despite the invalid data while generating a predictive output with a warning. These actions are designed to mitigate the impact of invalid data on the AI model's performance and ensure the reliability of the pipeline's outputs. When no invalid runtime data or invalid tokenized data is detected, the instant solution proceeds with executing the predictive pipeline. The AI model processes the valid input data, generating predictive outputs based on the trained model's capabilities.

The instant solution is configured to identify and retrieve missing data types from a database to enhance the reliability of an AI operational pipeline. The processor stores a model of the training data of the AI model in the storage of a software application. The model contains essential data attributes, patterns, and structures on which the AI model was trained. When the processor receives a request to execute the AI pipeline on new input data, it begins by determining when the input data is valid. The determination involves comparing the input data against the model of the training data to identify any discrepancies, such as missing data types or structural inconsistencies. When the processor identifies that the input data is missing specific data types, it proceeds to identify and retrieve the necessary datasets from a database. The processor determines the type of data that is missing based on the attributes defined in the training data model and uses the information to search through one or more databases to find datasets that include the required type of data. The search process involves examining metadata associated with the datasets, such as column names, data types, sources, and timestamps, to accurately locate the appropriate data. Once the relevant datasets are identified, the processor retrieves them from the database. The retrieval process ensures the missing data is collected and prepared for integration with the initial input data. The processor validates the retrieved data by comparing it to the model of the training data, ensuring it matches the expected formats and structures required for the AI pipeline.

The instant solution is designed to combine the input data with the additional input data to generate aggregated input data and execute the AI pipeline on the aggregated input data to generate the predictive output. When a request to execute the AI pipeline on new input data is received, the processor starts by determining the validity of the input data. This involves comparing the input data against the stored model of the training data to identify any discrepancies, such as missing data types or structural inconsistencies.

Upon identifying that the input data is missing specific types of data, the processor determines the type of data that is missing based on the attributes defined in the training data model. Instead of retrieving the missing data from existing datasets, the processor utilizes a second AI model to generate the additional input data. The processor inputs an identifier of the missing data type into the second AI model, which is configured to generate data that matches the required type and format. The second AI model processes the identifier and produces synthetic data that fulfills the criteria of the missing data. The generated data is designed to be consistent with the patterns and structures expected by the AI model in the operational pipeline. The generated additional input data is then validated by the processor, ensuring it meets the standards set by the training data model. After validation, the processor combines the generated additional input data with the initial input data, creating a comprehensive and valid dataset. The aggregated input data is used to execute the AI pipeline, allowing the AI model to generate accurate and reliable predictive outputs.

The instant solution is designed to enhance the reliability of an AI operational pipeline by validating tokenized input data against a model of tokenized training data. The processor stores a model of the training data, which includes tokenized data, in the software application's storage. The model contains essential data attributes, token structures, and patterns on which the AI model was trained. When a request is received to execute the AI pipeline on new input data, the processor converts the input data into tokens. The tokenization process is performed by a tokenizer within the AI pipeline, which breaks down the input data into smaller, manageable pieces known as tokens.

Once the input data is tokenized, the processor determines the validity of the tokenized input data by comparing it against the model of tokenized training data stored earlier. The processor examines various aspects of the tokenized data, such as the number of tokens, the structure of the tokens, and the presence of required tokens. This comparison helps to identify any discrepancies, such as missing tokens, incorrect token formats, or structural inconsistencies, that may affect the AI model's performance. When the tokenized input data is found to be invalid, the processor may initiate corrective actions. The actions may include retrieving additional data to replace missing tokens, modifying the input data to correct formatting issues, or replacing the tokenizer when it is determined to be the source of the problem. The processor ensures that all corrective actions align with the training data model to maintain data consistency and validity. After validating, the processor proceeds to execute the AI pipeline on the validated data. The AI model processes the tokenized input data to generate a predictive output, ensuring that the AI pipeline operates on accurately formatted and complete data and enhancing the reliability and accuracy of the AI model's predictions.

The instant solution is designed to enhance the reliability of an AI operational pipeline by enabling the selective deletion and replacement of invalid input data while retaining and utilizing valid data portions. When a request is received to execute the AI pipeline on new input data, the processor begins by evaluating the validity of this input data by comparing it against the stored model of the training data to identify any discrepancies or missing data types. Upon determining that a portion of the input data is invalid, the processor selectively deletes the invalid portion from the AI pipeline, preventing the invalid data from impacting the performance of the AI model and conserving computational resources by avoiding unnecessary processing of faulty data. While the invalid portion is being removed, the processor retains the valid portions of the input data within the pipeline. The retention ensures that any preprocessing, such as cleaning, normalization, or tokenization, performed on the valid data is not wasted. To replace the deleted invalid data, the processor retrieves new valid input data from appropriate data sources. The retrieval process involves identifying the type of data required based on the attributes outlined in the training data model and searching the software application's storage or other databases for datasets containing the necessary data types. The processor uses metadata such as column names, data types, and sources to accurately locate and retrieve the appropriate data.

Once the new valid input data is retrieved, the processor combines it with the retained valid data portions to generate a comprehensive and corrected dataset. The aggregated input data is validated to ensure it meets the standards set by the training data model. After validation, the processor resumes the execution of the AI pipeline on the aggregated input data, running the AI model to generate a predictive output.

The instant solution is designed using a neural network capability to generate a model of training data. The training data model is crucial for validating input data before it is processed by the AI pipeline. The processor is configured to train the AI model using a neural network capability. The training involves executing the AI model on a large set of training data, which includes various data attributes, patterns, and structures relevant to the AI model's intended application. During the training phase, the neural network learns to recognize and generalize from the data, improving its predictive accuracy and performance. As part of the training process, the processor generates a model of the training data. The model encapsulates the essential characteristics of the training data, such as data formats, structures, tokenization patterns, and other relevant attributes. The training data model serves as a reference for validating new input data that will be processed by the AI pipeline. The model is stored in the software application's storage, where it can be accessed for subsequent validation tasks.

When a request is received to execute the AI pipeline on new input data, the processor uses the stored training data model to determine the validity of the input data. This involves comparing the input data against the training data model to identify any discrepancies, such as missing values, incorrect data types, or structural inconsistencies. When the input data does not match the expected patterns and formats defined by the training data model, it is flagged as invalid. Upon identifying invalid input data, the processor may initiate corrective actions to ensure the data meets the required standards. These actions may include retrieving additional data, modifying the input data, or replacing parts of the data to align with the training data model. After validating, the processor proceeds to execute the AI pipeline, running the AI model on the validated data to generate a predictive output.

In another example of the instant solution, the instant solution enhances the reliability of AI operational pipelines by dynamically validating and correcting input data using a combination of neural network capabilities and real-time data retrieval mechanisms. The AI model is trained using a comprehensive neural network that processes large volumes of training data to identify patterns and structures for accurate predictions. During training, a model of the training data is created and stored in the software application's storage.

Upon receiving new input data for processing, the processor dynamically validates the input data against the stored training data model. When any discrepancies or missing data are detected, the processor retrieves additional data from various data sources, including external databases and internal repositories, using metadata to locate the expected data types. Dynamic retrieval ensures that the input data is corrected in real-time, thereby maintaining the integrity and accuracy of the data fed into the AI pipeline. The validated and corrected data is then used to execute the AI model, generating reliable predictive outputs.

In another example of the instant solution, the instant solution leverages synthetic data generation to ensure the completeness and validity of input data in AI operational pipelines. After training the AI model with a neural network and creating a detailed training data model, the instant solution validates incoming input data against this model. When discrepancies or missing data are identified, the processor employs a second AI model, such as an LLM, to generate synthetic data that matches the expected types and formats. The synthetic data generation process uses historical data patterns stored in the data sample database to create realistic and accurate data that fills the gaps in the input data. The synthetic data is validated against the training data model to ensure it meets the expected standards.

In another example of the instant solution, the instant solution focuses on validating and correcting tokenized and vectorized data within the AI operational pipeline. The AI model is trained using a neural network, and a model of the tokenized training data is created and stored. When new input data is received, it is tokenized by a tokenizer within the AI pipeline. The processor validates the tokenized data against the tokenized training data model to identify any discrepancies, such as missing tokens or incorrect formats. When invalid tokens are detected, the processor retrieves additional valid data or modifies the input data to correct the tokenization errors. The processor may also use a vectorizer to convert the tokenized data into vectors and then validate these vectors using a transformer model. The transformer model creates embeddings that identify clusters of data points, ensuring the tokenized and vectorized data aligns with the training data model. This real-time validation and correction process ensures that the AI pipeline processes accurately tokenized and vectorized data, enhancing the reliability and accuracy of the AI model's predictions.

In another example of the instant solution, the instant solution enhances the reliability of AI operational pipelines by implementing distributed data validation across cloud environments. The AI model is initially trained using a neural network, and a comprehensive training data model is generated and stored in a cloud-based storage system. This allows for scalable and flexible access to the training data model across multiple geographic locations. When input data is received for processing, the processor validates it against the stored training data model using distributed data validation modules deployed in various cloud regions. These modules collaborate to check the input data for discrepancies and missing values. When any issues are detected, the processor dynamically retrieves additional data from distributed databases or cloud-based data lakes. The retrieved data is validated, corrected (when invalid), and combined with the initial input data.

In another example of the instant solution, the instant solution enhances the reliability of AI operational pipelines by incorporating real-time data ingestion and validation mechanisms for streaming data. The AI model is trained using a neural network, and a model of the training data is created and stored. When real-time streaming data is ingested into the AI pipeline, the processor validates this data dynamically against the training data model. The processor uses a real-time data validation module to continuously monitor the streaming data, checking for any discrepancies or missing values as the data flows through the pipeline. When invalid data is detected, the processor pauses the data stream momentarily to retrieve additional valid data from streaming sources or data repositories. The retrieved data is validated and integrated with the initial streaming data. The AI pipeline resumes processing once the data is corrected, ensuring that the AI model receives valid and complete data in real-time or near real-time. This approach is particularly beneficial for applications requiring instant data processing, such as financial transactions, real-time analytics, and sensor data monitoring.

In another example of the instant solution, the instant solution enhances the reliability of AI operational pipelines by incorporating an adaptive training mechanism with a feedback loop. The AI model is trained using a neural network, and a detailed training data model is generated and stored. As the AI pipeline processes new input data, the processor continuously validates this data against the training data model to identify any discrepancies or missing values. The processor implements a feedback loop that monitors the AI model's performance on the processed data. When the predictive outputs deviate from the expected results, the feedback loop triggers a retraining process. The processor collects new data samples that contributed to the discrepancies and integrates them into the training dataset. The AI model is then retrained using this expanded dataset, refining its accuracy and adaptability. The adaptive training mechanism ensures that the AI model evolves with changing data patterns and environmental conditions, maintaining high reliability and accuracy. The continuous feedback loop enables the AI model to self-correct and refine its training over time, making it resilient to data anomalies and enhancing its predictive performance.

The instant solution enhances the reliability and efficiency of an AI operational pipelines by ensuring the validity of input data before processing. Upon receiving input data through the software application, the processor initiates the execution of the AI pipeline. During the execution, the processor compares the input data against the model of the training data to determine its validity. The comparison involves checking for inconsistencies, anomalies, and deviations from the expected data patterns, such as incorrect formats, missing values, or unexpected data types. When the input data is deemed invalid, the processor pauses the execution of the predictive process within the AI pipeline. The processor then stores an identifier of the specific location within the AI pipeline where the execution was paused. The identifier includes details such as a unique task ID, a timestamp, and a specific data processing stage, ensuring the process can be accurately resumed later.

The processor retrieves new input data from the software application's storage to rectify the invalid input data. The new input data may be sourced from existing databases or external data sources or synthetically generated to match the required format and structure. The processor modifies the original input data based on this new input data, creating a modified input data set that aligns with the expectations of the AI model. The processor resumes the execution of the predictive process at the previously paused location within the AI pipeline. By utilizing the stored identifier, the processor ensures that the pipeline continues processing seamlessly from the correct point, thereby conserving computational resources and avoiding restarting the entire process from the beginning.

The instant solution enhances the execution workflow of the predictive process within the AI pipeline. The predictive process comprises multiple execution tasks, each representing a distinct step in the data processing and model execution sequence. The input data is initially ingested and undergoes a series of preprocessing steps. The steps may include data cleaning, normalization, parsing, and tokenization. During this phase, the input data is prepared and transformed into a suitable format for analysis by the AI model. The processor oversees the preprocessing tasks, ensuring the data adheres to the expected structure and content requirements. Before the AI model executes on the input data, the processor performs a crucial validation check involving comparing the preprocessed input data against the model of training data stored in the memory. The validation process includes verifying the data's integrity, format, and consistency with the training data model. When the processor determines that the input data is not valid, it stops the execution of the predictive process before the AI model begins its analysis. By halting the process at this stage, the system prevents the AI model from operating on potentially erroneous or unsuitable data, safeguarding the quality and reliability of the model's outputs.

The processor pauses the execution of the predictive process and stores an identifier indicating the specific point within the pipeline where the process was halted. The identifier may include details such as the execution task ID, a timestamp, or a specific stage in the data processing sequence, allowing for precise resumption of the process after corrective actions are taken. To correct the invalid input data, the processor retrieves new data from the storage associated with the software application. The new data is used to modify the original input data, creating a revised data set that meets the validation criteria. Once the input data is corrected, the processor resumes the execution of the predictive process from the identified pause point, ensuring that the subsequent tasks, including the execution of the AI model, proceed with valid and accurate data. This ensures that the AI pipeline operates efficiently and reliably, minimizing the risk of processing invalid data and maximizing the accuracy of the AI model's predictions.

The instant solution is designed to determine whether the input data is invalid while simultaneously executing one or more execution tasks on the input data from among the plurality of execution tasks. In the AI pipeline, the predictive process is divided into multiple execution tasks, which include various stages such as data ingestion, preprocessing (e.g., cleaning, normalization, parsing, and tokenization), and, eventually, the execution of the AI model itself. The processor manages these tasks simultaneously, optimizing workflow and resource utilization. As the input data progresses through the pipeline, the processor continuously monitors its validity. The validation process checks the input data against the training data model stored in memory. The validation criteria may include data format, structure, consistency, and adherence to the expected patterns derived from the training data. The processor can promptly detect anomalies or deviations that indicate invalid data by performing these checks concurrently with other tasks. For instance, while the data preprocessing module cleans and tokenizes the input data, the processor simultaneously compares the intermediate outputs with the training data model. When discrepancies or errors are identified, such as missing values, unexpected data types, or incorrect formats, the processor flags the input data as invalid, allowing the system to quickly identify and address data issues without waiting for the completion of all preprocessing tasks.

Upon determining that the input data is invalid, the processor halts the execution of the predictive process before the AI model begins its analysis. It stores an identifier indicating the exact point in the pipeline where the execution was paused. This identifier includes relevant information such as the execution task ID, a timestamp, or the specific stage in the data processing sequence. The processor then retrieves new, valid input data from the software application's storage, using this new data to correct and modify the original input data. Once the input data is validated and corrected, the processor resumes the execution of the predictive process from the identified pause point, ensuring that subsequent tasks, including the execution of the AI model, proceed with accurate and valid data.

The instant solution is configured to store an entry in temporary storage, which includes an identifier of the predictive process together with a timestamp at which the predictive process is stopped. When the processor identifies that the input data is invalid based on a comparison with the model of training data, it pauses the execution of the predictive process within the AI pipeline. The processor stores a detailed entry in a temporary storage medium. The entry includes a unique identifier of the predictive process, ensuring that it can be accurately referenced later. The identifier may be a process ID, a task ID, or any other unique marker that distinguishes this specific execution instance from others. In addition to the identifier, the processor records a timestamp indicating the exact moment the predictive process was halted. The timestamp is crucial for maintaining the sequence and continuity of operations, as it allows the instant solution to understand precisely when the process was interrupted. The combination of the identifier and the timestamp provides a comprehensive snapshot of the process state at the time of interruption.

The temporary storage can be any suitable volatile or non-volatile memory medium, such as RAM, a cache, or a dedicated temporary storage database. The storage medium is designed to retain state information securely and make it readily accessible for the processor when needed. After storing the entry in the temporary storage, the processor proceeds to address the invalid input data by retrieving new, valid data from the software application's storage. The new data is used to modify and correct the original input data, generating a revised dataset that meets the validation criteria. Once the input data is corrected, the processor retrieves the stored entry from the temporary storage. Using the identifier and timestamp, the processor accurately resumes the predictive process from the exact point of interruption, ensuring that the AI pipeline continues from where it left off without repeating previously completed tasks, conserving computational resources and maintaining process efficiency.

The instant solution is designed to delete the entry from the temporary storage in response to the execution of the predictive process being resumed. When the processor determines that the input data is invalid and pauses the predictive process within the AI pipeline, it stores an entry in temporary storage. The entry includes a unique identifier for the predictive process and a timestamp marking the exact point of interruption. The stored information allows the processor to resume the process accurately once the data issues are resolved. After the invalid input data is corrected, the processor resumes the execution of the predictive process. The process of resuming involves retrieving the stored entry from the temporary storage, using the identifier and timestamp to ensure the predictive process continues from the exact point of interruption.

Once the predictive process has successfully resumed, the temporary storage entry that recorded the interruption becomes obsolete. To maintain optimal storage efficiency and ensure that the temporary storage does not become cluttered with outdated entries, the processor is configured to delete the entry from the temporary storage. The deletion occurs immediately after the execution of the predictive process is resumed. The deletion of the temporary storage entry involves removing the specific record associated with the paused predictive process, ensuring that temporary storage space is freed up for future use, maintaining the system's overall efficiency, and avoiding potential memory overflow or degradation in performance.

The instant solution is designed to identify one or more downstream tasks to execute in the AI pipeline based on a current task of the AI pipeline being performed on the input data and prevent one or more downstream tasks from being executed via the software application. When the AI pipeline receives input data, the processor begins executing a series of tasks to process this data, ultimately leading to executing an AI model to generate predictions or inferences. The tasks may include data ingestion, cleaning, normalization, tokenization, and other preprocessing steps. As the processor oversees the execution of these tasks, it continuously monitors the input data to ensure its validity. The monitoring involves comparing the input data against the model of training data stored in the memory. When the processor detects that the input data is invalid, it takes immediate action to prevent the propagation of invalid data through the AI pipeline. Specifically, the processor identifies the current task being performed on the input data at the moment the invalidity is detected. Based on the current task, the processor determines which downstream tasks are scheduled to follow in the pipeline. The downstream tasks may include further preprocessing steps, the execution of the AI model, or any subsequent data analysis operations.

To prevent the execution of these downstream tasks on invalid data, the processor intervenes and halts their execution. The intervention is managed via the software application controlling the AI pipeline. By stopping the downstream tasks, the processor ensures that no further processing resources are wasted on invalid data and that the AI model is not exposed to data that may lead to inaccurate or unreliable outputs. This preemptive measure involves dynamically adjusting the execution flow of the AI pipeline. The processor uses the software application to manage task execution, ensuring that only valid data progresses through each stage of the pipeline, minimizing the risk of erroneous data affecting the predictive outcomes, and optimizing the use of computational resources.

The instant solution is configured to stop a task within the AI pipeline from completing execution on the input data and store an identifier of the task's start as the location within the AI pipeline at which the execution of the predictive process is paused. As the AI pipeline processes input data, it executes a series of tasks, each contributing to the overall predictive process. The tasks may involve data ingestion, cleaning, normalization, tokenization, and other preparatory steps before the AI model generates predictions. The processor oversees the execution of these tasks, ensuring that each step is performed correctly. During the execution of a specific task, the processor continuously validates the input data against the model of training data stored in memory. When the processor determines that the input data is invalid, it halts the execution of the current task before it completes, ensuring that no further processing is conducted on the invalid data.

To facilitate the precise resumption of the predictive process, the processor records an identifier of the start of the halted task. The identifier may include details such as the task ID, a timestamp, or any other unique marker that accurately specifies the point at which the task began. By storing this identifier, the processor effectively bookmarks the exact location within the AI pipeline where the interruption occurred. The stored identifier is crucial for resuming the predictive process seamlessly after the invalid data issue is resolved. The processor uses the identifier to restart the task from its beginning, ensuring that the AI pipeline continues processing from the correct point. After recording the identifier, the processor retrieves new, valid input data from the software application's storage. The new data is used to modify and correct the original input data, creating a revised dataset that meets the validation criteria. Once the input data is validated and corrected, the processor resumes the execution of the halted task, using the stored identifier to ensure that the process continues from the precise point of interruption.

In another example of the instant solution, the instant solution hosts various components of the AI pipeline across multiple servers or cloud instances. The processor is designed to manage and coordinate these distributed tasks, ensuring seamless communication and data flow between different nodes. Each server or node in the distributed system includes a memory unit configured to store AI models and corresponding training data. The processor on each node is capable of executing specific tasks within the AI pipeline, such as data ingestion, preprocessing, and model execution. The processor continuously validates real-time input data as it flows through the pipeline. When invalid data is detected at any node, the processor halts the execution of the current task, stores an identifier indicating the point of interruption, and communicates this information to the central coordinating processor. The central coordinating processor retrieves new, valid input data, modifies the invalid data, and instructs the relevant node to resume the task from the recorded interruption point, ensuring efficient use of resources and maintaining the integrity of the AI pipeline across the distributed system.

In another example of the instant solution, the instant solution enhances the AI pipeline's ability to adaptively tokenize and validate data, ensuring robust processing even with varying data formats and structures. The processor includes an adaptive tokenization module capable of dynamically adjusting tokenization strategies based on the input data's characteristics. The module utilizes machine learning techniques to optimize tokenization parameters, ensuring accurate and efficient data representation. As the input data is tokenized, the processor concurrently validates the tokens against the model of training data. When discrepancies are detected, the processor halts the pipeline, stores the interruption point, and retrieves new input data or adjusts tokenization parameters to correct the data. After correcting the input data, the processor resumes the predictive process from the stored interruption point.

In another example of the instant solution, the instant solution deploys an AI pipeline in a cloud environment, featuring an integrated feedback loop that continuously refines data validation and processing based on real-time feedback. The AI pipeline is hosted on a cloud platform, leveraging scalable computing resources to handle large volumes of data and complex predictive tasks. The cloud environment includes memory units for storing AI models and training data, and processors for executing the pipeline tasks. The processor incorporates a feedback loop that continuously monitors the performance of the AI pipeline. It collects data on the accuracy of predictions, validation errors, and processing times, using this information to adjust validation parameters and increase the pipeline's performance. When invalid data is detected, the processor halts the pipeline, stores the interruption point, and uses the feedback loop to retrieve insights on the optimal corrective actions. It then modifies the input data accordingly and resumes the predictive process from the recorded point. The feedback-driven approach ensures that the AI pipeline remains efficient and continuously refines over time.

In another example of the instant solution, the instant solution uses edge computing to perform AI pipeline tasks closer to the data source, reducing latency and bandwidth usage. The AI pipeline is deployed on edge devices, such as IoT gateways, industrial controllers, or mobile devices. Each edge device includes memory for storing AI models and training data and a processor for executing the pipeline tasks. The processor on each edge device continuously validates input data in real time, comparing it with the training data model stored in the memory. When the input data is found to be invalid, the processor pauses the task, stores an identifier of the interruption point, and locally retrieves or generates new input data to correct the invalid data. After correcting the data, the processor resumes the predictive process from the stored interruption point.

The instant solution includes a memory communicably coupled to a processor, wherein the processor is configured to train an AI model using a neural network capability based on training data to generate a trained AI model. The trained AI model is integrated into an AI pipeline via a software application designed to receive input data and start execution of the AI pipeline on the input data. The processor determines during the runtime of the AI pipeline that the content included in the input data is not valid based on comparing the content included in the input data to the training content included in the training data. Upon determining the input data is invalid, the processor stops the execution of the AI pipeline on the invalid input data and presents a notification via a GUI of the software application, indicating that the input data is invalid. The AI pipeline consists of several interconnected modules, including a feature pipeline, a training pipeline, and an inference pipeline. During the inference process, the AI pipeline receives input data and executes the AI model on the input data to generate output predictions (inferences). When the input data is incorrect, incomplete, or not what the model is expecting, the output predictions are unreliable. The instant solution addresses this by implementing a validation step during the runtime of the AI pipeline. The validation involves comparing the input and training data to ensure consistency and accuracy. For example, the AI pipeline includes a pre-processing module that prepares the input data by performing cleaning, normalization, and tokenization. The tokenized input data is validated by a validation module, which compares it with a model of the training data stored in a validation data storage. When discrepancies are found, such as missing columns or unexpected data formats, the validation module identifies the data as invalid.

In such cases, the processor stops the execution of the AI pipeline to prevent the invalid data from affecting the subsequent steps and wasting computational resources. The user is notified via a GUI, which provides details about the invalid data, allowing corrective actions to be taken. This enhances the reliability of the AI operational pipeline and conserves computational resources by ensuring only valid data is processed. The instant solution includes mechanisms to retrieve and integrate valid input data. For example, the instant solution can fetch additional data from existing storage locations or generate synthetic data to fill in the missing or invalid parts. Once the input data is validated and corrected, the AI pipeline resumes execution from the point it was paused, thereby maintaining the continuity of the process without redoing the entire operation from the beginning.

The instant solution is designed to train the AI model based on the execution of the AI model on tokenized training data and create the token data model based on data attributes included in the tokenized training data. The instant solution includes training an AI model using a neural network capability based on training data to generate a trained AI model. During the training process, the training data undergoes various pre-processing steps, such as cleaning, normalization, and tokenization. The tokenization process converts the input data into smaller, more manageable pieces called tokens. These tokens are used to create a token data model, which represents the structure, format, and characteristics of the tokenized training data. Once the AI model is trained, it is integrated into an AI pipeline via a software application. The AI pipeline consists of multiple interconnected modules designed to streamline the process of building, training, evaluating, and deploying AI models. The software application facilitates the receipt of input data, which is then processed by the AI pipeline.

During the execution of the AI pipeline, the instant solution includes receiving input data via the software application and starting the execution of the AI pipeline on the input data. As the input data enters the pipeline, it undergoes various pre-processing steps, including tokenization. The tokenized input data is then validated against the token data model. The validation process involves comparing the tokenized input data with the token data model. The token data model includes information such as the expected number of tokens, token sizes, and the overall structure of the tokenized data. When the tokenized input data does not match the expected format, structure, or content defined by the token data model, it is deemed invalid. Examples of invalid data include missing tokens, unexpected token sizes, or discrepancies in the overall token structure. Upon determining that the input data is invalid, the instant solution includes stopping the execution of the AI pipeline on the invalid input data. This prevents the AI model from generating unreliable predictions based on incorrect or incomplete data.

The instant solution is designed to determine whether the tokenizer is valid based on at least one of the sizes of the tokens and the amount of the tokens that are output by the tokenizer. Initially, the instant solution includes training an AI model using a neural network capability based on training data to generate a trained AI model. During the training process, the training data undergoes various pre-processing steps, such as cleaning, normalization, and tokenization. The tokenization process converts the input data into smaller, more manageable pieces called tokens. These tokens are used to create a token data model, which represents the structure, format, and characteristics of the tokenized training data. Once the AI model is trained, it is integrated into an AI pipeline via a software application. The AI pipeline consists of multiple interconnected modules designed to streamline the process of building, training, evaluating, and deploying AI models. The software application facilitates the receipt of input data, which is then processed by the AI pipeline. During the execution of the AI pipeline, the method includes receiving input data via the software application and starting the execution of the AI pipeline on this input data. As the input data enters the pipeline, it undergoes various pre-processing steps, including tokenization. A tokenizer performs the tokenization, which converts the raw input data into tokenized data. The pre-processed input data, now in tokenized form, is validated against the token data model.

The validation process involves comparing the tokenized input data with the token data model. The token data model includes information such as the expected number of tokens, token sizes, and the overall structure of the tokenized data. When the tokenized input data does not match the expected format, structure, or content defined by the token data model, it is deemed invalid. Examples of invalid data include missing tokens, unexpected token sizes, or discrepancies in the overall token structure. The instant solution includes determining whether the tokenizer is valid by comparing the tokenizer's tokens and the token data model of the AI model. The validation process ensures that the tokenizer accurately converts input data into the expected tokenized format. The instant solution involves validating the tokenizer by comparing the output tokens to the expected tokens defined in the token data model, checking for consistency in token sizes, and ensuring the correct number of tokens is generated.

The instant solution is designed to determine whether the tokenizer is valid and simultaneously executes one or more tasks of the AI pipeline on the tokens. The instant solution includes training an AI model using a neural network capability based on training data to generate a trained AI model. During the training process, the training data undergoes various pre-processing steps, such as cleaning, normalization, and tokenization. The tokenization process converts the input data into smaller, more manageable pieces called tokens. These tokens are used to create a token data model, which represents the structure, format, and characteristics of the tokenized training data. Once the AI model is trained, it is integrated into an AI pipeline via a software application. The AI pipeline consists of multiple interconnected modules designed to streamline the process of building, training, evaluating, and deploying AI models. The software application facilitates the receipt of input data, which is then processed by the AI pipeline. The instant solution receives input data via the software application and starts the execution of the AI pipeline on this input data. As the input data enters the pipeline, it undergoes various pre-processing steps, including tokenization. The tokenization is performed by a tokenizer, which converts the raw input data into tokenized data. The pre-processed input data, now in tokenized form, is validated against the token data model.

The validation process involves comparing the tokenized input data with the token data model. The token data model includes information such as the expected number of tokens, token sizes, and the overall structure of the tokenized data. When the tokenized input data does not match the expected format, structure, or content defined by the token data model, it is deemed invalid. Examples of invalid data include missing tokens, unexpected token sizes, or discrepancies in the overall token structure. The tokenizer validation includes determining whether the tokenizer is valid based on a comparison of the tokens produced by the tokenizer and the token data model of the AI model. Specifically, the validation involves checking whether the size of the tokens and the number of tokens produced to match the expected values defined in the token data model. This ensures that the tokenizer accurately converts input data into the expected tokenized format. For instance, the method involves analyzing the output tokens to ensure they meet the predefined criteria, such as the number of tokens, token length, and token consistency. When the tokenizer produces too many or too few tokens or the token sizes are inconsistent with the token data model, the tokenizer is deemed invalid. Additionally, the method may involve simultaneously executing one or more tasks of the AI pipeline on the tokens to determine when the tokenizer is valid. When the tokenizer fails to meet these validation criteria, the AI pipeline's execution is paused to prevent further processing of invalid data. Upon determining that the input data is invalid due to an invalid tokenizer, the instant solution includes stopping the execution of the AI pipeline on the invalid input data and preventing the AI model from generating unreliable predictions based on incorrect or incomplete data. The instant solution presents a notification via a GUI of the software application, indicating that the input data is invalid. The notification allows users to take corrective actions, such as providing additional data or correcting the invalid input. The instant solution also includes a mechanism for pausing the AI pipeline when invalid data is detected. The instant solution stores an identifier of the location within the AI pipeline where the execution was paused, allowing the pipeline to resume from this point once valid input data is available, ensuring that the steps already performed on valid data are not repeated, conserving computational resources and maintaining the efficiency of the process. Furthermore, the instant solution includes retrieving additional input data to replace the invalid data. This can involve fetching data from existing databases or generating synthetic data using an AI model. The additional input data is validated against the token data model before being integrated into the AI pipeline. Once the input data is deemed valid, the execution of the AI pipeline resumes from the paused location, continuing the process with the corrected data.

The instant solution is designed to determine that the tokenizer is not valid, stop the execution of the AI pipeline, replace the tokenizer with a new tokenizer, and resume the execution of the AI pipeline with the new tokenizer. The instant solution trains an AI model using a neural network capability based on training data to generate a trained AI model. During the training process, the training data undergoes various pre-processing steps, including cleaning, normalization, and tokenization. The tokenization process converts the input data into smaller, more manageable pieces called tokens. The tokens are used to create a token data model, which represents the structure, format, and characteristics of the tokenized training data. Once the AI model is trained, it is integrated into an AI pipeline via a software application. The AI pipeline consists of multiple interconnected modules designed to streamline the process of building, training, evaluating, and deploying AI models. The software application facilitates the receipt of input data, which is then processed by the AI pipeline. During the execution of the AI pipeline, the instant solution includes receiving input data via the software application and starting the execution of the AI pipeline on the input data. As the input data enters the pipeline, it undergoes various pre-processing steps, including tokenization. The tokenization is performed by a tokenizer, which converts the raw input data into tokenized data. The pre-processed input data, now in tokenized form, is validated against the token data model.

The validation process involves comparing the tokenized input data with the token data model. The token data model includes information such as the expected number of tokens, token sizes, and the overall structure of the tokenized data. When the tokenized input data does not match the expected format, structure, or content defined by the token data model, it is deemed invalid. Examples of invalid data include missing tokens, unexpected token sizes, or discrepancies in the overall token structure. The instant solution determines whether the tokenizer is valid based on a comparison of the tokens produced by the tokenizer and the token data model of the AI model. Specifically, the validation involves checking whether the size of the tokens and the number of tokens produced match the expected values defined in the token data model, ensuring that the tokenizer is accurately converting input data into the expected tokenized format. For instance, the instant solution involves analyzing the output tokens to ensure they meet the predefined criteria, such as the number of tokens, token length, and token consistency. When the tokenizer produces too many or too few tokens or the token sizes are inconsistent with the token data model, the tokenizer is deemed invalid.

Additionally, the instant solution may involve simultaneously executing one or more tasks of the AI pipeline on the tokens to determine when the tokenizer is valid. When the tokenizer fails to meet these validation criteria, the AI pipeline's execution is paused to prevent further processing of invalid data. Upon determining that the tokenizer is invalid, the instant solution includes stopping the execution of the AI pipeline. The instant solution replaces the invalid tokenizer with a new tokenizer. The new tokenizer is configured to properly convert the input data into the expected tokenized format, as defined by the token data model. This replacement process ensures the input data can be correctly tokenized according to the expected format. Once the new tokenizer is in place, the execution of the AI pipeline resumes, starting from the point where it was paused duc to the invalid tokenizer. The instant solution re-processes the input data using the new tokenizer to produce tokenized data that adheres to the token data model.

The instant solution is designed to determine that the tokenizer is not valid, stop the execution of the AI pipeline, modify the input data to generate modified input data, and resume the execution of the AI pipeline with the modified input data. The instant solution trains an AI model using a neural network capability based on training data to generate a trained AI model. During the training process, the training data undergoes various pre-processing steps, such as cleaning, normalization, and tokenization. The tokenization process converts the input data into smaller, more manageable pieces called tokens. These tokens are used to create a token data model, which represents the structure, format, and characteristics of the tokenized training data. Once the AI model is trained, it is integrated into an AI pipeline via a software application. The AI pipeline consists of multiple interconnected modules designed to streamline the process of building, training, evaluating, and deploying AI models. The software application facilitates the receipt of input data, which is then processed by the AI pipeline. During the execution of the AI pipeline, the instant solution includes receiving input data via the software application and starting the execution of the AI pipeline on this input data. As the input data enters the pipeline, it undergoes various pre-processing steps, including tokenization. The tokenization is performed by a tokenizer, which converts the raw input data into tokenized data. The pre-processed input data, now in tokenized form, is validated against the token data model.

The validation process involves comparing the tokenized input data with the token data model. The token data model includes information such as the expected number of tokens, token sizes, and the overall structure of the tokenized data. When the tokenized input data does not match the expected format, structure, or content defined by the token data model, it is deemed invalid. Examples of invalid data include missing tokens, unexpected token sizes, or discrepancies in the overall token structure. The instant solution determines whether the tokenizer is valid based on a comparison of the tokens produced by the tokenizer and the token data model of the AI model. Specifically, the validation involves checking whether the size of the tokens and the number of tokens produced to match the expected values defined in the token data model. For instance, the instant solution involves analyzing the output tokens to ensure they meet the predefined criteria, such as the number of tokens, token length, and token consistency. When the tokenizer produces too many or too few tokens or the token sizes are inconsistent with the token data model, the tokenizer is deemed invalid. Additionally, the instant solution may involve simultaneously executing one or more tasks of the AI pipeline on the tokens to determine when the tokenizer is valid. When the tokenizer fails to meet these validation criteria, the AI pipeline's execution is paused to prevent further processing of invalid data.

The instant solution is configured to determine that the tokenizer is valid and continues to execute the AI pipeline on the tokens. The tokenization is performed by a tokenizer, which converts the raw input data into tokenized data. The pre-processed input data, now in tokenized form, is validated against the token data model. The validation process involves comparing the tokenized input data with the token data model. The token data model includes information such as the expected number of tokens, token sizes, and the overall structure of the tokenized data. When the tokenized input data does not match the expected format, structure, or content defined by the token data model, it is deemed invalid. Examples of invalid data include missing tokens, unexpected token sizes, or discrepancies in the overall token structure. The instant solution determines whether the tokenizer is valid based on a comparison of the tokens produced by the tokenizer and the token data model of the AI model. Specifically, the validation involves checking whether the size of the tokens and the number of tokens produced match the expected values defined in the token data model. When the tokenizer produces too many or too few tokens or the token sizes are inconsistent with the token data model, the tokenizer is deemed invalid. Additionally, the instant solution may involve simultaneously executing one or more tasks of the AI pipeline on the tokens to determine when the tokenizer is valid. When the tokenizer meets these validation criteria, it is deemed valid. Upon determining that the tokenizer is valid, the instant solution includes continuing the execution of the AI pipeline on the valid tokens and processing the tokens through the various stages of the AI pipeline, which may include feature extraction, model inference, and post-processing steps.

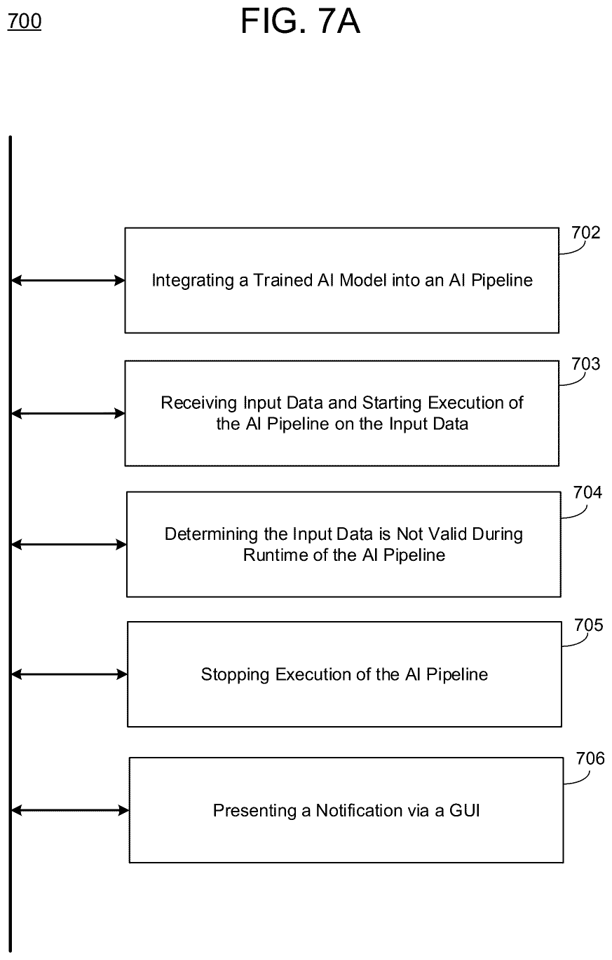

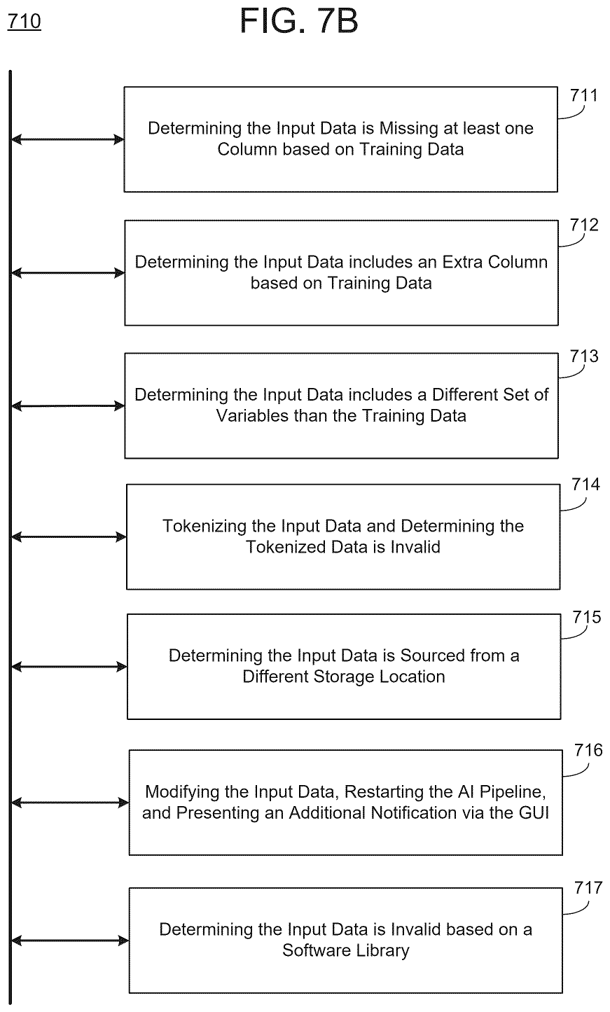

FIG. 7A illustrates a method 700 of detecting invalid input data during runtime of an AI pipeline according to examples and features of the instant solution. For example, the method 700 may be performed by a host platform such as a cloud platform, a web server, a software application, a combination of systems, and the like. Referring to FIG. 7A, in 702, the method may include integrating a trained AI model into an AI pipeline via a software application. In 703, the method may include receiving input data via the software application and starting execution of the AI pipeline on the input data.

In 704, the method may include determining, during runtime of the AI pipeline, that content included in the input data is not valid based on a comparison of the content included in the input data to training content included in training data. In 705, the method may include stopping execution of the AI pipeline on the input data based on the input data not being valid. In 706, the method may include presenting a notification via a GUI of the software application which indicates the input data is not valid.

FIG. 7B illustrates a method 710 of detecting invalid input data during runtime of an AI pipeline according to other examples and features of the instant solution. For example, the method 710 may be performed by a host platform such as a cloud platform, a web server, a software application, a combination of systems, and the like. Referring to FIG. 7B, in 711, the method may include determining that the input data is missing at least one column of content based on the comparison of the content included in the input data to the training content included in the training data. In 712, the method may include determining that the input data includes at least one column of content that is not included in the training content of the training data based on the comparison of the content included in the input data to the training content included in the training data. In 713, the method may include determining that the input data includes a different set of variables in comparison to the training data.

In 714, the method may further include tokenizing the input data to generate tokenized input data prior to starting execution of the AI pipeline, wherein the determining comprises determining that the content include in the input data is invalid based on a comparison of the tokenized input data to tokenized training content included in the training data. In 715, the method may include determining that the input data is sourced from a different storage location than the training data. In 716, the method may further include modifying the input data that is not valid to generate valid input data, restarting the execution of the AI pipeline on the valid input data, and presenting an additional notification via the GUI of the software application which indicates the AI pipeline has been restarted. In 717, the method may include determining that content included in the input data is not valid based execution of a library accessible to the software application.

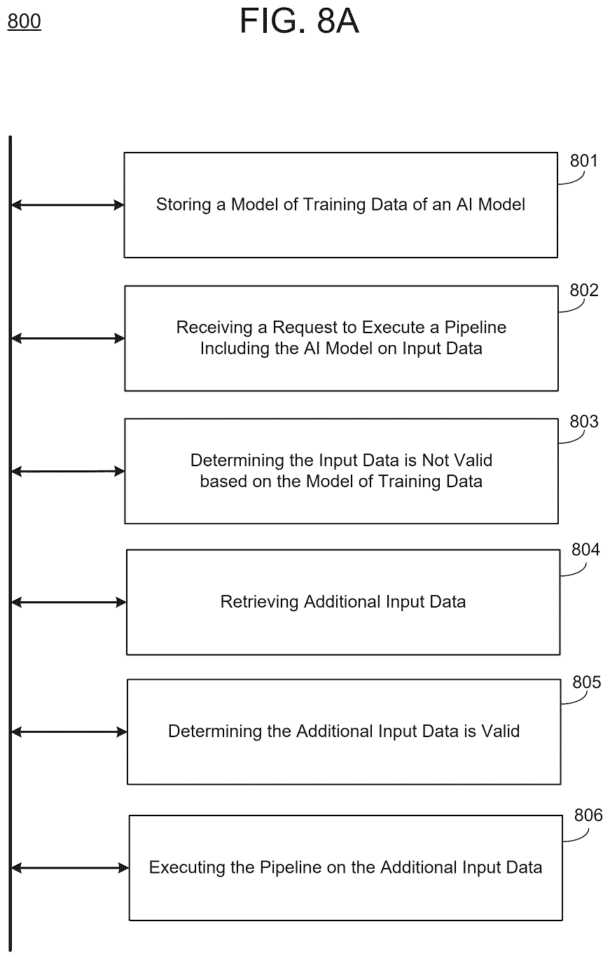

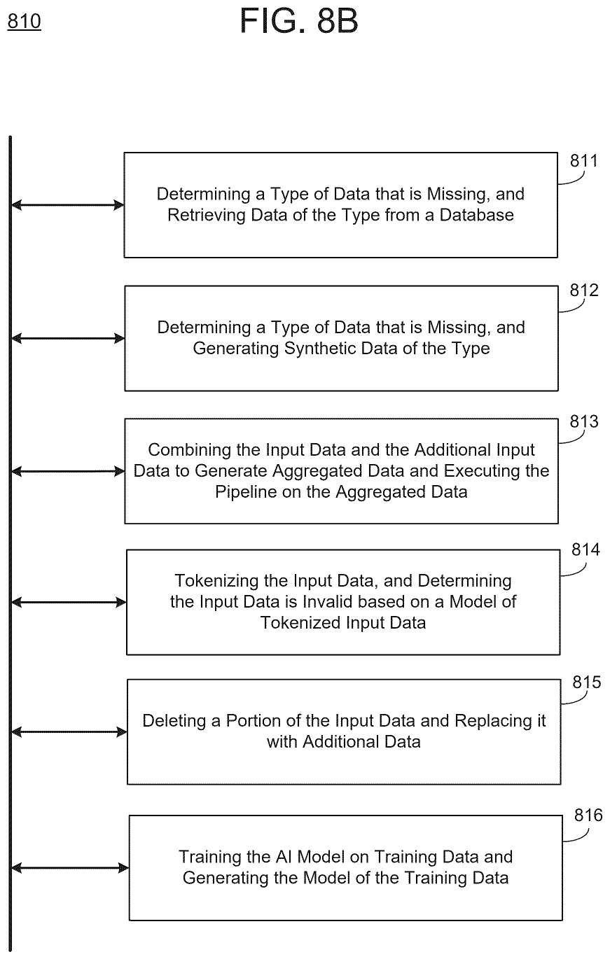

FIG. 8A illustrates a method 800 of correcting invalid input data during runtime of an AI pipeline according to examples and features of the instant solution. For example, the method 800 may be performed by a host platform such as a cloud platform, a web server, a software application, a combination of systems, and the like. Referring to FIG. 8A, in 801, the method may include storing a model of training data of an artificial intelligence (AI) model in a storage of a software application. In 802, the method may include receiving a request to execute an artificial intelligence pipeline including the AI model on input data via the software application.

In 803, the method may include determining that the input data is not valid data based on a comparison of the input data to the model of the training data. IN 804, the method may include retrieving additional input data from the storage of the software application. In 805, the method may include determining that the additional input data is valid data based on a comparison of the additional input data to the model of the input data. In 806, the method may include executing the artificial intelligence pipeline including the AI model on the additional input data to generate a predictive output.

FIG. 8B illustrates a method 810 correcting invalid input data during runtime of an AI pipeline according to other examples and features of the instant solution. For example, the method 810 may be performed by a host platform such as a cloud platform, a web server, a software application, a combination of systems, and the like. Referring to FIG. 8B, in 811, the method may include determining a type of data that is missing from the input data based on the model of the input data, identifying one or more datasets stored within a database which include the type of data that is missing based on metadata of the one or more datasets, and retrieving the one or more datasets from the database. In 812, the method may include determining a type of data that is missing from the input data based on the model of the input data, and generating the additional input data based on execution of a second AI model on an identifier of the type of data that is missing from the input data.

In 813, the method may include combining the input data with the additional input data to generate aggregated input data, and executing the artificial intelligence pipeline on the aggregated input data to generate the predictive output. In 814, the method may further include tokenizing the input data to generate tokenized input data, wherein the determining comprises determining that the input data is not valid data based on a comparison of the tokenized input data to a model of tokenized training data. In 815, the method may further include deleting a portion of the input data from the artificial intelligence pipeline while retaining a second portion of the input data within the artificial intelligence pipeline, retrieving new valid input data, and combining the new valid input data with the second portion of the input data to generate the additional input data. In 816, the method may further include training the AI model using a neural network capability based on execution of the AI model on training data, and generating the model of the training data based on a format of the training data.

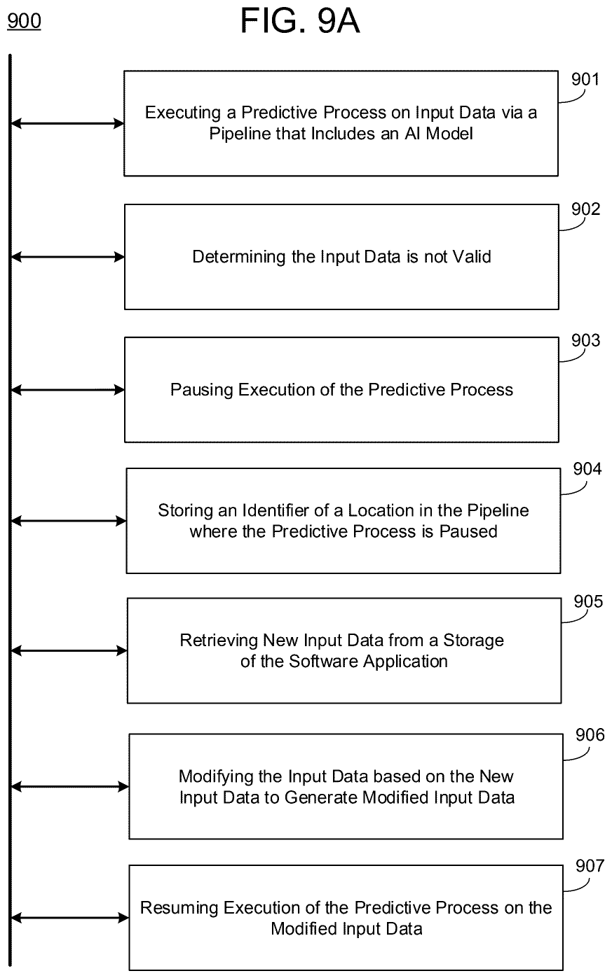

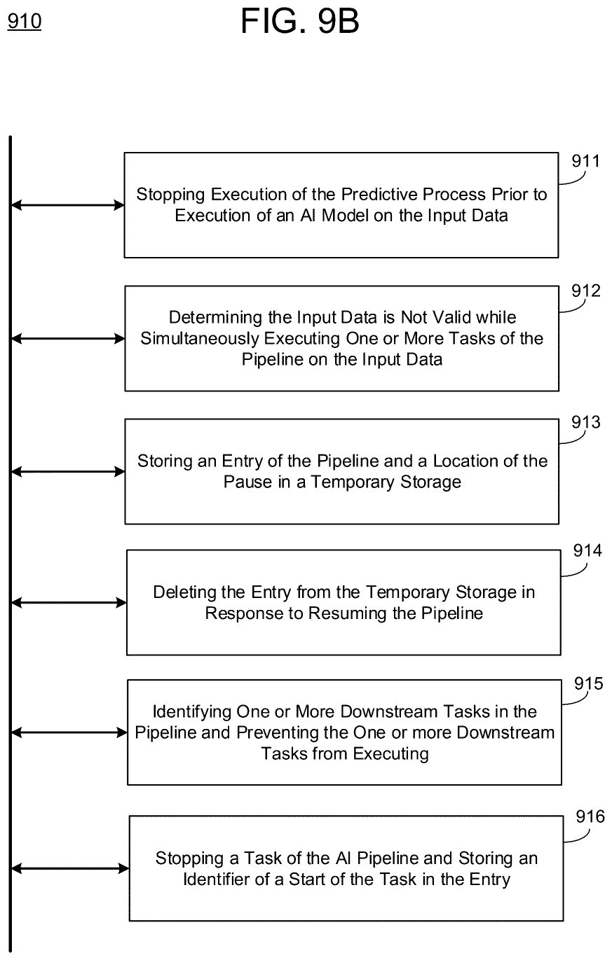

FIG. 9A illustrates a method 900 of pausing an AI pipeline when invalid data is detected and resuming the AI pipeline from the paused location according to examples and features of the instant solution. For example, the method 900 may be performed by a host platform such as a cloud platform, a web server, a software application, a combination of systems, and the like. Referring to FIG. 9A, in 901, the method may include executing, via a software application, a predictive process on input data via an artificial intelligence (AI) pipeline, wherein the AI pipeline comprises at least one AI model and a model of training data for the at least one AI model. In 902, the method may include determining that the input data is not valid data based on a comparison of the input data to the model of the training data.

In 903, the method may include pausing execution of the predictive process by the AI pipeline on the input data based on the input data not being valid data. In 904, the method may include storing an identifier of a location within the AI pipeline at which the execution of the predictive process is paused via the software application. In 905, the method may include retrieving new input data from a storage of the software application. In 906, the method may include modifying the input data based on the new input data to generate modified input data. In 907, the method may include resuming execution of the predictive process on the modified input data at the location based on the identifier of the location stored in the storage of the software application.

FIG. 9B illustrates a method 910 of pausing an AI pipeline when invalid data is detected and resuming the AI pipeline from the paused location according to other examples and features of the instant solution. For example, the method 910 may be performed by a host platform such as a cloud platform, a web server, a software application, a combination of systems, and the like. Referring to FIG. 9B, in 911, the method may include stopping the execution of the predictive process prior to the execution of the AI model on the input data. In 912, the method may include determining the input data is not valid while simultaneously executing one or more execution tasks on the input data from among the plurality of execution tasks. In 913, the method may include storing an entry in a temporary storage which includes an identifier of the predictive process together with a timestamp at which the predictive process is stopped.

In 914, the method may include deleting the entry from the temporary storage in response to the resuming of the execution of the predictive process. In 915, the method may include identifying one or more downstream tasks to execute in the AI pipeline based on a current task of the AI pipeline being performed on the input data, and preventing the one or more downstream tasks from executing via the software application. In 916, the method may include stopping a task within the AI pipeline from completing execution on the input data, and the storing comprises storing an identifier of a start of the task as the location within the AI pipeline at which the execution of the predictive process is paused.

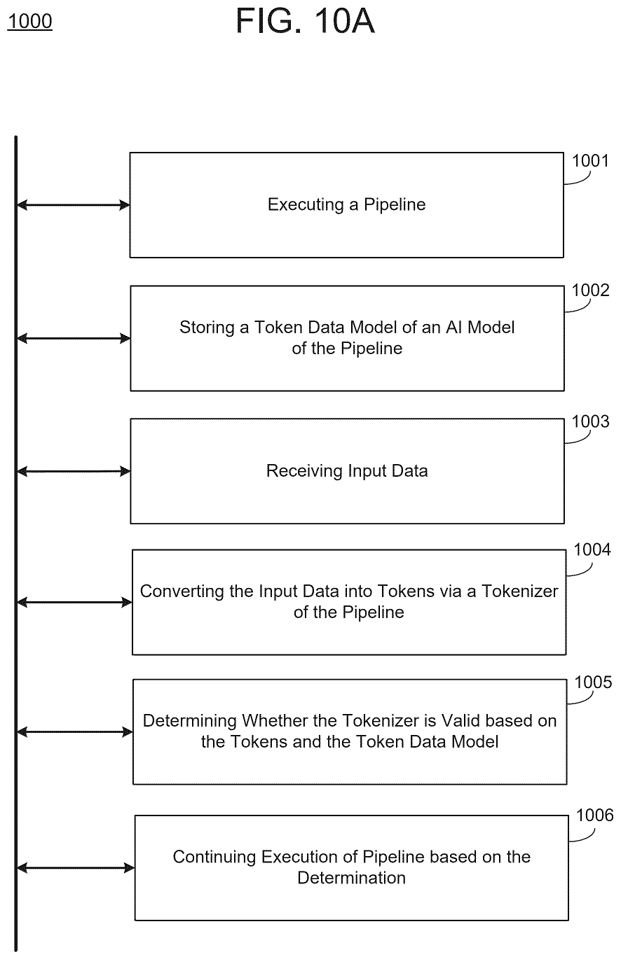

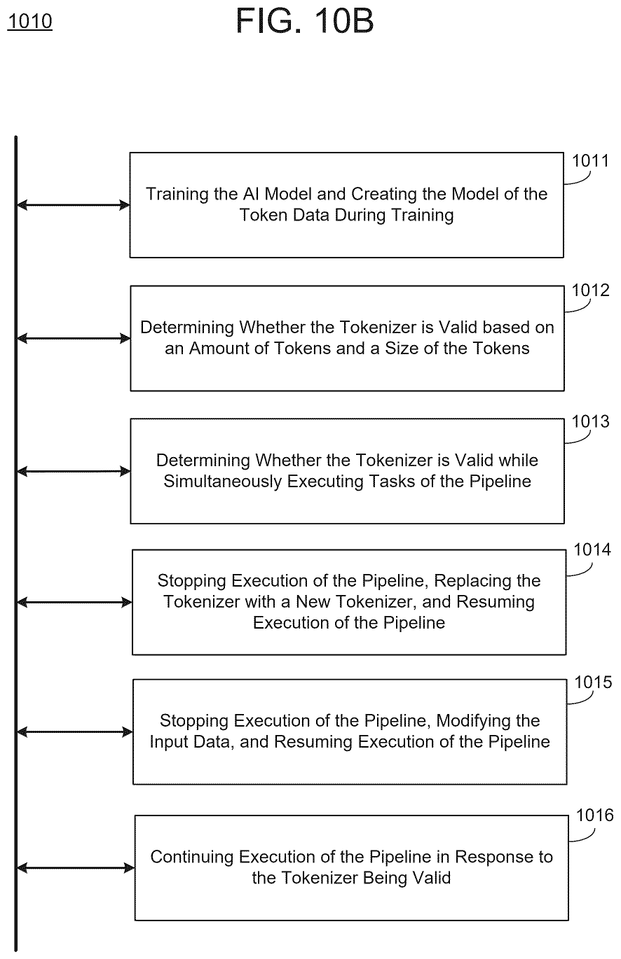

FIG. 10A illustrates a method 1000 of validating a tokenizer of an AI pipeline according to examples and features of the instant solution. For example, the method 1000 may be performed by a host platform such as a cloud platform, a web server, a software application, a combination of systems, and the like. Referring to FIG. 10A, in 1001, the method may include executing an artificial intelligence pipeline including an artificial intelligence (AI) model via a software application. In 1002, the method may include storing a token data model of the AI model via a storage of the software application.

In 1003, the method may include receiving input data via an artificial intelligence pipeline of the software application. In 1004, the method may include converting the input data into tokens via execution of a tokenizer within the artificial intelligence pipeline on the input data. In 1005, the method may include determining whether the tokenizer is valid based on a comparison of the tokens and the token data model of the AI model. In 1006, the method may include continuing execution of the artificial intelligence pipeline of the software application based on whether the tokenizer is valid.

FIG. 10B illustrates a method 1010 of validating a tokenizer of an AI pipeline according to other examples and features of the instant solution. For example, the method 1010 may be performed by a host platform such as a cloud platform, a web server, a software application, a combination of systems, and the like. Referring to FIG. 10B, in 1011, the method may further include training the AI model based on execution of the AI model on tokenized training data, and creating the token data model based on data attributes included in the tokenized training data. In 1012, the method may include determining whether the tokenizer is valid based on at least one of a size of the tokens and an amount of the tokens which are output by the tokenizer.

In 1013, the method may include determining whether the tokenizer is valid whiles simultaneously executing one or more tasks of the artificial intelligence pipeline on the tokens. In 1014, the method may include determining the tokenizer is not valid, stopping execution of the artificial intelligence pipeline, replacing the tokenizer with a new tokenizer, and resuming the execution of the artificial intelligence pipeline with the new tokenizer. In 1015, the method may include determining the tokenizer is not valid, stopping execution of the artificial intelligence pipeline, modifying the input data to generate modified input data, and resuming the execution of the artificial intelligence pipeline with the modified input data. In 1016, the method may include determining the tokenizer is valid and the continuing comprises continuing to execute the artificial intelligence pipeline on the tokens.

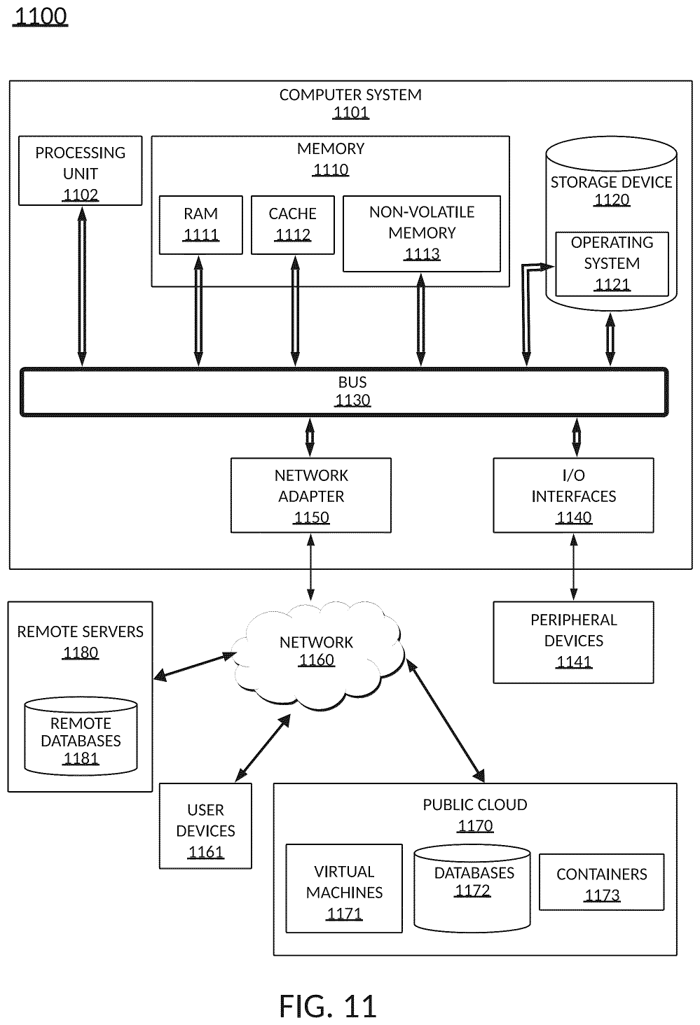

The examples and features of the instant solution may be implemented in one or more of the elements described or depicted herein, including for example, the elements described or depicted in FIG. 11. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 11 illustrates an example computer system architecture, which may represent or be integrated in any of the above-described components, etc.

FIG. 11 illustrates a computing environment according to the instant solution's example features, structures, or characteristics. FIG. 11 is not intended to suggest any limitation as to the scope of use or functionality of features, structures, or characteristics of the instant solution of the application described herein. Regardless, the computing environment 1100 can be implemented to perform any of the functionalities described herein. In computing environment 1100, there is a computer system 1101, operational within numerous other general-purpose or special-purpose computing system environments or configurations.

Computer system 1101 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 1160 or querying a database. Depending upon the technology, the performance of a computer-implemented method may be distributed among multiple computers and among multiple locations. However, in this presentation of the computing environment 1100, a detailed discussion is focused on a single computer, specifically computer system 1101, to keep the presentation as simple as possible.

Computer system 1101 may be located in a cloud, even though it is not shown in a cloud in FIG. 11. On the other hand, computer system 1101 may not be in a cloud except to any extent as may be affirmatively indicated. Computer system 1101 may be described in the general context of computer system-executable instructions, such as program modules, executed by a computer system 1101. Generally, program modules may include routines, programs, objects, components, logic, data structures, and so on that perform tasks or implement certain abstract data types. As shown in FIG. 11, computer system 1101 in computing environment 1100 is shown in the form of a general-purpose computing device. The components of computer system 1101 may include but are not limited to, at least one processor or processing unit 1102, a system memory 1110, and a bus 1130 that couples various system components, including system memory 1110 to processing unit 1102.

Processing unit 1102 includes at least one computer processor of any type now known or to be developed. The processing unit 1102 may contain circuitry distributed over multiple integrated circuit chips. The processing unit 1102 may also implement multiple processor threads and multiple processor cores. Cache 1112 is a memory that may be in the processor chip package(s) or located “off-chip,” as depicted in FIG. 11. Cache 1112 is typically used for data or code accessed by the threads or cores running on the processing unit 1102. In some computing environments, processing unit 1102 may be designed to work with qubits and perform quantum computing.

Memory 1110 is any volatile memory now known or to be developed in the future. Examples include dynamic random-access memory (RAM) 1111 or static type RAM 1111. Typically, the volatile memory is characterized by random access, but this may not be the characterization unless affirmatively indicated. In computer system 1101, memory 1110 is in a single package. It is internal to computer system 1101, but alternatively or additionally, the volatile memory may be distributed over multiple packages and/or located externally with respect to computer system 1101. By way of example, memory 1110 can be provided for reading from and writing to a non-removable, non-volatile magnetic media (shown as storage device 1120, and typically called a “hard drive”). Memory 1110 may include at least one program product having a set (e.g., at least one) of program modules configured to carry out the functions of various features, structures, or characteristics of the instant solution of the application. A typical computer system 1101 may include cache 1112, a specialized volatile memory generally faster than RAM 1111 and generally located closer to the processing unit 1102. Cache 1112 stores frequently accessed data and instructions accessed by the processing unit 1102 to speed up processing time. The computer system 1101 may also include non-volatile memory 1113 in the form of ROM, PROM, EEPROM, and flash memory. Non-volatile memory 1113 often contains programming instructions for starting the computer, including the basic input/output system (BIOS) and information to start the operating system 1121.

Computer system 1101 may include a removable/non-removable, volatile/non-volatile computer storage device 1120. For example, storage device 1120 can be a non-removable, non-volatile magnetic media (not shown and typically called a “hard drive”). At least one data interface can connect it to the bus 1130. In features, structures, or characteristics of the instant solution where computer system 1101 has a large amount of storage (for example, where computer system 1101 locally stores and manages a large database), then this storage may be provided by peripheral storage devices 1120 designed for storing very large amounts of data, such as a storage area network (SAN) that is shared by multiple, geographically distributed computers.

The operating system 1121 is software that manages computer system 1101 hardware resources and provides common services for computer programs. Operating system 1121 may take several forms, such as various known proprietary operating systems or open-source Portable Operating System Interface type operating systems that employ a kernel.

The bus 1130 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 1130 is the signal conduction path that allows the various components of computer system 1101 to communicate.

Computer system 1101 may communicate with at least one peripheral device, 1141, via an input/output (I/O) interface, 1140. Such devices may include a keyboard, a pointing device, a display, etc.; at least one device that enables a user to interact with computer system 1101; and/or any devices (e.g., network card, modem, etc.) that enable computer system 1101 to communicate with at least one other computing devices. Such communication can occur via I/O interface 1140. As depicted, I/O interface 1140 communicates with the other components of computer system 1101 via bus 1130.

Network adapter 1150 enables the computer system 1101 to connect and communicate with at least one network 1160, such as a local area network (LAN), a wide area network (WAN), and/or a public network (e.g., the Internet). It bridges the computer's internal bus 1130 and the external network, exchanging data efficiently and reliably. The network adapter 1150 may include hardware, such as modems or Wi-Fi signal transceivers, and software for packetizing and/or de-packetizing data for communication network transmission. Network adapter 1150 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 1160 is any computer network that can receive and/or transmit data. Network 1160 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 1160 may be replaced and/or supplemented by LANs designed to communicate data between devices in a local area, such as a Wi-Fi network. The network 1160 typically includes computer hardware such as copper transmission cables, optical transmission fibers, wireless transmission, routers, firewalls, switches, gateway computers, edge servers, and network infrastructure known now or to be developed in the future. Computer system 1101 connects to network 1160 via network adapter 1150 and bus 1130.

User devices 1161 are any computer systems used and controlled by an end user in connection with computer system 1101. For example, in a hypothetical case where computer system 1101 is designed to provide a recommendation to an end user, this recommendation may typically be communicated from network adapter 1150 of computer system 1101 through network 1160 to a user device 1161, allowing user device 1161 to display, or otherwise present, the recommendation to an end user. User devices can be a wide array, including personal computers, laptops, tablets, hand-held, mobile phones, etc.

A public cloud 1170 is an on-demand availability of computer system resources, including data storage and computing power, without direct active management by the user. Public clouds 1170 are often distributed, with data centers in multiple locations for availability and performance. Computing resources on public clouds 1170 are shared across multiple tenants through virtual computing environments comprising virtual machines 1171, databases 1172, containers 1173, and other resources. A container 1173 is an isolated, lightweight software for running a software application on the host operating system 1121. Containers 1173 are built on top of the host operating system's kernel and contain software applications and some lightweight operating system APIs and services. In contrast, virtual machine 1171 is a software layer with an operating system 1121 and kernel. Virtual machines 1171 are built on top of a hypervisor emulation layer designed to abstract a host computer's hardware from the operating software environment. Public clouds 1170 generally offers databases 1172, abstracting high-level database management activities. At least one element described or depicted in FIG. 11 can perform at least one of the actions, functionalities, or features described or depicted herein.

Remote servers 1180 are any computers that serve at least some data and/or functionality over a network 1160, for example, WAN, a virtual private network (VPN), a private cloud, or via the Internet to computer system 1101. These networks 1160 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 1180 can also host remote databases 1181, with the database located on one remote server 1180 or distributed across multiple remote servers 1180. Remote databases 1181 are accessible from database client applications installed locally on the remote server 1180, other remote servers 1180, user devices 1161, or computer system 1101 across a network 1160. An AI/ML model described or depicted here may reside fully or partially on any of the elements described or depicted in FIG. 11.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus, comprising:
a memory configured to store an artificial intelligence (AI) model; and
a processor configured to:
integrate a trained AI model into an AI pipeline via a software application,
receive input data via the software application and start execution of the AI pipeline on the input data,
determine, during runtime of the AI pipeline, that content included in the input data is not valid based on a comparison of the content included in the input data to training content included in training data,
stop execution of the AI pipeline on the input data based on the input data not being valid, and
present a notification via a graphical user interface (GUI) of the software application which indicates the input data is not valid.

2. The apparatus of claim 1, wherein the processor is configured to determine that the input data is missing at least one column of content based on the comparison of the content included in the input data to the training content included in the training data.

3. The apparatus of claim 1, wherein the processor is configured to determine that the input data includes at least one column of content that is not included in the training content of the training data based on the comparison of the content included in the input data to the training content included in the training data.

4. The apparatus of claim 1, wherein the processor is configured to determine that the input data includes a different set of variables in comparison to the training data.

5. The apparatus of claim 1, wherein the processor is configured to tokenize the input data to generate tokenized input data prior to execution of the AI pipeline, and determine that the content include in the input data is invalid based on a comparison of the tokenized input data to tokenized training content included in the training data.

6. The apparatus of claim 1, wherein the processor is configured to determine that the input data is sourced from a different storage location than the training data.

7. The apparatus of claim 1, wherein the processor is configured to modify the input data that is not valid to generate valid input data, restart the execution of the AI pipeline on the valid input data, and present an additional notification via the GUI of the software application which indicates the AI pipeline has been restarted.

8. The apparatus of claim 1, wherein the processor is configured to determine that content included in the input data is not valid based execution of a library accessible to the software application.

9. A method comprising:
integrating a trained artificial intelligence (AI) model into an AI pipeline via a software application;
receiving input data via the software application and starting execution of the AI pipeline on the input data;
determining, during runtime of the AI pipeline, that content included in the input data is not valid based on a comparison of the content included in the input data to training content included in training data;
stopping execution of the AI pipeline on the input data based on the input data not being valid; and
presenting a notification via a graphical user interface (GUI) of the software application which indicates the input data is not valid.

10. The method of claim 9, wherein the determining that the content included in the input data is not valid comprises determining that the input data is missing at least one column of content based on the comparison of the content included in the input data to the training content included in the training data.

11. The method of claim 9, wherein the determining that the content included in the input data is not valid comprises determining that the input data includes at least one column of content that is not included in the training content of the training data based on the comparison of the content included in the input data to the training content included in the training data.

12. The method of claim 9, wherein the determining that the input data is invalid comprises determining that the input data includes a different set of variables in comparison to the training data.

13. The method of claim 9, comprising tokenizing the input data to generate tokenized input data prior to starting execution of the AI pipeline, wherein the determining comprises determining that the content include in the input data is invalid based on a comparison of the tokenized input data to tokenized training content included in the training data.

14. The method of claim 9, wherein the determining that the content included in the input data is not valid comprises determining that the input data is sourced from a different storage location than the training data.

15. The method of claim 9, comprising modifying the input data that is not valid to generate valid input data, restarting the execution of the AI pipeline on the valid input data, and presenting an additional notification via the GUI of the software application which indicates the AI pipeline has been restarted.

16. The method of claim 9, wherein the determining comprises determining that content included in the input data is not valid based execution of a library accessible to the software application.

17. A computer-readable storage medium comprising instructions which when executed by a computer cause a processor to perform:
integrating a trained artificial intelligence (AI) model into an AI pipeline via a software application;
receiving input data via the software application and starting execution of the AI pipeline on the input data;
determining, during runtime of the AI pipeline, that content included in the input data is not valid based on a comparison of the content included in the input data to training content included in training data;
stopping execution of the AI pipeline on the input data based on the input data not being valid; and
presenting a notification via a graphical user interface (GUI) of the software application which indicates the input data is not valid.

18. The computer-readable storage medium of claim 17, wherein the determining that the content included in the input data is not valid comprises determining that the input data is missing at least one column of content based on the comparison of the content included in the input data to the training content included in the training data.

19. The computer-readable storage medium of claim 17, wherein the determining that the content included in the input data is not valid comprises determining that the input data includes at least one column of content that is not included in the training content of the training data based on the comparison of the content included in the input data to the training content included in the training data.

20. The computer-readable storage medium of claim 17, wherein the determining that the input data is invalid comprises determining that the input data includes a different set of variables in comparison to the training data.
